(19) United States
(12) Patent Application Publication
(10) Pub. No.: US 2010/0113653 A1
(43) Pub. Date: May 6, 2010

(54) METHOD FOR PRODUCING CELLULOSE RESIN FILM, DEVICE THEREOF, AND OPTICAL CELLULOSE RESIN FILM

(75) Inventor: Tadashi Ueda, Fujinomiya-shi (JP)

Correspondence Address: YOUNG & THOMPSON, 209 Madison Street, Suite 500, Alexandria, VA, 22314, US

(73) Assignee: FUJIFILM CORPORATION, Tokyo (JP)

(21) Appl. No.: 12/442,787

(22) PCT Filed: Sep. 25, 2007
(86) PCT No.: PCT/JP2007/068514

§ 371 Date: Mar. 25, 2009

(30) Foreign Application Priority Data
Sep. 26, 2006 (JP) 2006-261383

(51) Int. Cl. C08L 1/02; B29C 47/00; B29C 47/36

(52) U.S. Cl. 524/35; 264/176.1; 425/377

(57) ABSTRACT

A method for producing a cellulose resin film includes: feeding molten resin into a die through piping, and casting it as a sheet onto a rotating cooling support. In the piping, leaf disc filters removing contaminants from the molten resin are circularly provided in a hollow shaft. A filtration device having a connection hole connects the leaf disc filters and the shaft inside. A static mixer has an element satisfying condition (A) in a lower step of the filtration device, decontaminated molten resin is rekneaded by the static mixer and fed into the die: (A) when viscosity of the molten resin is ρ(Pa·s), a charging amount of the molten resin is V (kg/h), number of connection holes in the filtration device is m, and number of steps of the static element in the static mixer is n, ρ×V<2ⁿ×m×V is satisfied.

### TECHNICAL FIELD

The present invention relates to a method for producing a cellulose resin film and a device thereof, and an optical cellulose resin film, and in particular, a method for producing a cellulose resin film having preferable product quality for use in a liquid crystal display device and a device thereof, and an optical cellulose resin film.

### BACKGROUND ART

A thermoplastic resin film such as a cellulose acylate film is used for various optical films of a liquid crystal display device, and for example, by stretching a thermoplastic resin film in a longitudinal direction (lengthwise direction) and a transverse direction (widthwise direction), an in-plane retardation (Re) and a retardation in a thickness direction (Rth) are exhibited, and the film is used as a retardation film of a crystal liquid display device, and the enlargement of a visual angle has been intended to perform (for example see Patent Document 1).

A thermoplastic resin film is generally produced by melting a thermoplastic resin by a single-screw extruder and discharging the molten resin from the extruder to feed into a die, and extruding the molten resin in a form of a sheet from the die so as to be solidified by cooling.

Patent Document 1: National Publication of International Patent Application No. 6-501040

### DISCLOSURE OF THE INVENTION

### Problems to be Solved by the Invention

However, in such a conventional production method as described above, fine contaminants are frequently contained in a molten resin molten by an extruder, and therefore, there was a problem such that scratch defect is exhibited in a formed film.

On the other hand, when contaminants in a molten resin are removed by a filtration device provided with a leaf disc filter before forming into a film, there were problems such that scratches are formed when the molten resin (in particular, the molten resin with high viscosity) passes through fine holes and flow paths in the filtration device, and scratch defect is exhibited in the formed film by causing temperature unevenness and viscosity unevenness in the molten resin.

The present invention was made in view of such circumstances, and objects of the present invention are to provide a method for producing a cellulose resin film and a device thereof, which suppress scratch defect of a film mainly caused by removing contaminants in a molten resin and can obtain a cellulose resin film having excellent optical property, and to provide an optical cellulose resin film.

### Means for Solving the Problems

A first aspect of the present invention provides, for the purpose of achieving the above-mentioned objects, a method for producing a cellulose resin film, comprising the steps of melting a cellulose resin by an extruder, feeding the molten resin into a die through a piping, and casting the molten resin in a form of a sheet onto a running or rotating cooling support from the die to solidify the sheet by cooling, wherein the piping comprises a filtration device having a plurality of leaf disc filters for removing a contaminant in the molten resin by the extruder circularly provided in a hollow shaft and connection holes connecting the leaf disc filters and the shaft inside, and a static mixer having a static element that satisfies the following condition (A) in a lower step of the filtration device, and the molten resin from which a contaminant is removed by the leaf disc filters is rekneaded by the static mixer and fed into the die:

(A) ρ×V<2ⁿ×m×V is satisfied, when assumed that a viscosity of the molten resin is ρ(Pa·s), a discharge amount of the molten resin is V (kg/h), the number of the connection holes in the filtration device is m, and the number of steps of the static element in the static mixer is n.

According to the first aspect, when a contaminant in a molten resin is removed in a filtration device provided with leaf disc filters, scratches easily formed mainly at the time of passing the molten resin through connection holes connecting the leaf disc filters and a shaft inside can be removed by uniformly kneading by a static mixer. Thereby, exhibiting scratch defect in a film after film formation can be suppressed. Here, the number of steps of the static element is referred to as the number of the minimum unit of repeated shapes.

A second aspect of the present invention is characterized in that a temperature of the molten resin at a discharge opening of the die is 220° C. or higher.

According to the second aspect, a viscosity of the molten resin can be lowered, and a film surface can be made flat and smooth. In the second aspect, an upper limit of the temperature of the molten resin at a discharge opening of the die is within the range where the molten resin is not thermally deteriorated, and in the case of a cellulose acylate film, the upper limit is preferably set at 220° C. or higher and 230° C. or lower.

A third aspect of the present invention is characterized in that a gear pump is used as a means for conveying a liquid to the leaf disk filters in the first or second aspects.

According to the third aspect, the molten resin can be uniformly conveyed into the leaf disc filters and the static mixer.

A forth aspect of the present invention is characterized in that a distance between a discharge opening of the die and a surface of the cooling support is 100 mm or less in any one of the first to third aspects.

According to the fourth aspect, since a distance from the molten resin discharged from the die until reaching the cooling support can be shortened, the molten resin is cooled during this time so that unevenness in temperatures can be suppressed.

A fifth aspect is characterized in that, in any one of the first to fourth aspects, the cooling support is in a touch roll system of nipping the molten resin discharged in a form of a sheet from the die with a pair of rollers.

According to the fifth aspect, a surface state of the film solidified by cooling can be further improved.

A sixth aspect is characterized in that the method for producing a cellulose resin film according to any one of the first to fifth aspects is applied to an optical cellulose resin film.

A seventh aspect is characterized in that, in the sixth aspect, a depth and a width of scratches formed on a surface of the optical cellulose resin film are both 1 μm or less, and the scratches are 10 scratches/10 cm or less in a lengthwise direction of the film.

According to the sixth aspect and the seventh aspect, a cellulose resin film excellent in optical property can obtained. The optical film includes a film having various functions such as an optical compensation film, an antireflection film, an anti-glaring film etc. Here, the scratch defect can be measured by, for example, a three-dimensional contact type roughness meter manufactured by Mitutoyo Corporation.

An eighth aspect of the present invention provides, for the purpose of achieving the above-mentioned objects, a device for producing a cellulose resin film by melting a cellulose resin by an extruder, feeding the molten resin into a die through a piping, and casting the molten resin in a form of a sheet onto a running or rotating cooling support from the die to solidify the sheet by cooling to form a film, wherein the piping comprises a filtration device having a plurality of leaf disc filters for removing a contaminant in the molten resin by the extruder circularly provided in a hollow shaft and connection holes connecting the leaf disc filters and the shaft inside, and a static mixer having a static element that satisfies the following condition (A) in a lower step of the filtration device:

(A) ρ×V<2ⁿ×m×V is satisfied, when assumed that a viscosity of the molten resin is ρ(Pa·s), a discharge amount of the molten resin is V (kg/h), the number of the connection holes in the filtration device is m, and the number of steps of the static element in the static mixer is n.

A ninth aspect is characterized in that a gear pump is provided between the extruder and the leaf disc filters in the eighth aspect.

### ADVANTAGE OF THE INVENTION

According to the present invention, scratch defect of a film mainly caused by removing contaminants in a molten resin is suppressed and a cellulose resin film having excellent optical property can be obtained.

### BRIEF DESCRIPTION OF THE DRAWINGS

FIG. 1 is a structural view of a film production device to which the present invention is applied;

FIG. 2 is a schematic view illustrating a structure of an extruder;

FIG. 3 is a schematic view illustrating a screw of a compression part in FIG. 2;

FIG. 4 is a schematic view illustrating a structure of a filtration device;

FIG. 5 is a schematic view illustrating a leaf disc filter in FIG. 4;

FIG. 6 is a schematic view illustrating another embodiment in FIG. 1;

FIG. 7 is a graph of the present Examples; and

FIG. 8 is a graph of the present Examples.

### DESCRIPTION OF SYMBOLS

10 . . . Production device
12 . . . Cellulose acylate film
14 . . . Film formation process part
16 . . . Longitudinal stretching process part
18 . . . Transverse stretching process part
20 . . . Wind-up process part
22 . . . Extruder
23 . . . Piping
24 . . . Die
25 . . . Filtration device
27 . . . Static mixer
27a . . . Element
26 . . . Cooling drum (casting roll system)
32 . . . Cylinder
34 . . . Screw axis
36, 36′ . . . Screw blades
38 . . . Screw
66 . . . Cooling roller (touch roll system)
68 . . . Press roller (touch roll system)
56 . . . Leaf disc filter
60 . . . Shaft
62 . . . Connection path
A . . . Feed part
B . . . Compression part
C . . . Conveying and measuring part

### BEST MODE FOR CARRYING OUT THE INVENTION

Hereinafter, preferred embodiments of the method for producing a cellulose resin film and the device thereof according to the present invention will be described in accordance with appended drawings. Although an example of the production of a cellulose acylate film is illustrated as a cellulose resin film in the present embodiments, the present invention is not limited to the present embodiments, but can be applied to the production of other cellulose resin films.

First, the method for producing a cellulose acylate film according to the present invention will be described.

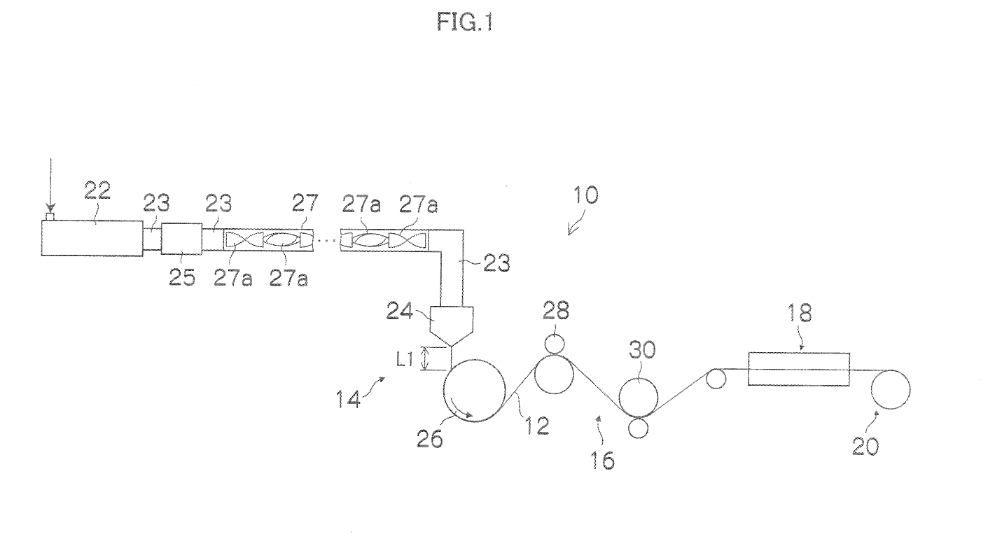

FIG. 1 is a schematic view illustrating one example of a schematic structure of the production device of a cellulose acylate film. As shown in FIG. 1, a production device 10 is mainly constituted with a film formation process part 14 of producing a cellulose acylate film 12 before stretching, a longitudinal stretching process part 16 of longitudinally stretching the cellulose acylate film 12 produced in the film formation process part 14, a transverse stretching process part 18 of transversely stretching the cellulose acylate film 12, and a wind-up process part 20 of winding up the stretched cellulose acylate film 12.

In the film formation process part 14, a cellulose acylate resin molten in an extruder 22 is discharged in a form of a sheet from a die 22 and cast on a rotating cooling drum 26 to be solidified by rapid cooling, and the cellulose acylate film 12 is obtained. This cellulose acylate film 12 is separated from the cooling drum 26, and then sent to the longitudinal stretching process part 16 and the transverse stretching process part 18 sequentially, and wound up in a form of a roll in the wind-up process part 20. Thus, the stretched cellulose acylate film 12 can be produced. In addition, a band-type cooling support may be used in place of the cooling drum 26. The band-type cooling support is bridged between a driving roller and a driven roller, and runs with drawing an elliptical orbit by driving the driving roller.

Hereinafter, details of the respective process parts will be described.

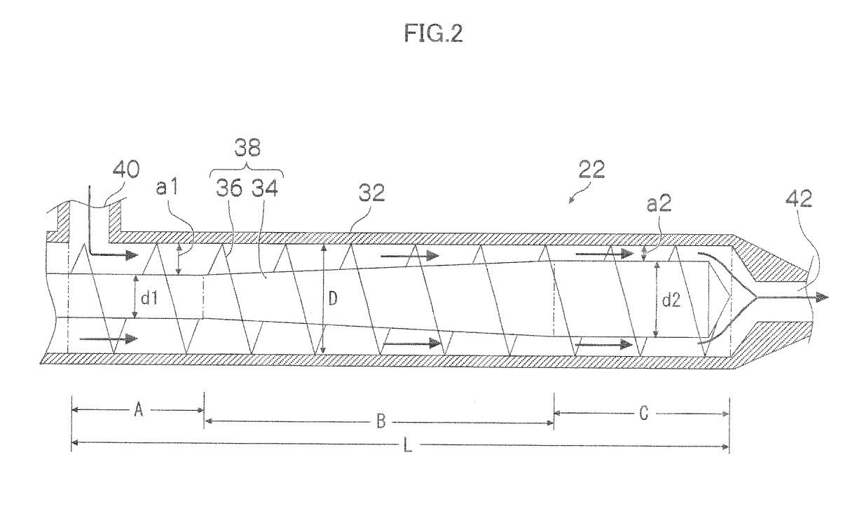

FIG. 2 is a cross-sectional view illustrating the extruder 22 with a single screw in the film formation process part 14.

As shown in FIG. 2, a single screw 38 having a flight 36 is disposed on a screw axis 34 in a cylinder 32, and a cellulose acylate resin is fed into the cylinder 32 from a hopper not shown through a feed opening 40. The inside of the cylinder 32 is constituted with a feed part (region expressed by A) of quantitatively conveying the cellulose acylate resin fed from the feed opening 40, a compression part (region expressed by B) of kneading and compressing the cellulose acylate resin, and a measuring part (region expressed by C) of measuring the cellulose acylate resin that is kneaded and compressed, in this order from the feed opening 40. The cellulose acylate resin molten in the extruder 22 is continuously sent from the discharge opening 42 to the die 24.

A screw compression ratio of the extruder 22 is set at 2.5 to 4.5, and a L/D is set at 20 to 70. Herein, the screw compression ratio means a volume ratio of the feed part A to the measuring part C, that is, expressed by a volume of the feed part A par a unit length/a volume of the measuring part C par a unit length, and calculated using an outer diameter d1 of the screw axis 34 of the feed part A, an outer diameter d2 of the screw axis 34 of the measuring part C, a groove diameter a1 of the feed part A, and a groove diameter a2 of the measuring part C. In addition, the L/D means a ratio of a cylinder length (L) to a cylinder inner diameter (D) in FIG. 2. Further, an extrusion temperature (exit temperature of the extruder 22) is set at 190 to 240° C. When the temperature inside the extruder 22 exceeds 240° C., it is advised that a cooling machine (not shown) may be provided between the extruder 22 and the die 24.

The extruder 22 may be a single-screw extruder or a twin-screw extruder, but when a screw compression ratio is too small as lowering 2.5, a cellulose acylate resin is not sufficiently kneaded, an insoluble portion may be generated or shear heat generation is small so as to be insufficient in melting, and fine crystals are easily remained in the cellulose acylate film after production. Further, bubbles are likely to be mixed in. Thereby, when a cellulose acylate film is stretched, the remained crystals inhibit stretchability and orientation cannot be sufficiently increased. On the contrary, when the screw compression ratio is too large as exceeding 4.5, shear stress is overloaded and a resin easily deteriorates due to heat generation, and thus, the cellulose acylate film after production easily takes yellowish tone. In addition, as shear stress is overloaded, cutting of molecules is caused and a molecular weight is lowered, and mechanical strength of a film is lowered. Therefore, in order that cellulose acylate film after production hardly takes the yellowish tone and is hardly broken in stretching, the screw compression ratio is preferably in the range from 2.5 to 4.5, more preferably in the range from 2.8 to 4.2, and particularly preferably in the range from 3.0 to 4.0.

When a L/D is too small as lowering 20, insufficient melting and insufficient kneading are caused, fine crystals are likely to remain in the cellulose acylate film after production in the same manner as in the case of a small compression ratio. On the contrary, when the L/D is too large as exceeding 70, a retaining time of a cellulose acylate resin in the extruder 22 is too long, and deterioration of the resin is easily caused. In addition, as the retaining time it too long, cutting of molecules is caused, a molecular weight is lowered, and mechanical strength of the film is lowered. Therefore, in order that cellulose acylate film after production hardly takes a yellowish tone and is hardly broken in stretching, the L/D is preferably in the range from 20 to 70, more preferably in the range from 22 to 45, and particularly preferably in the range from 24 to 40.

When an extrusion temperature (exit temperature of the extruder 22) is as low as less than 190° C., melting of a crystal is insufficient, which causes easily remaining fine crystals in the cellulose acylate film after production, and when the cellulose acylate film is stretched, the remained crystals inhibit stretchability and orientation cannot be sufficiently increased. On the contrary, when the extrusion temperature is too high as exceeding 240° C., the cellulose acylate resin deteriorates, which results in degrading a degree of yellow tone (YI value). Therefore, in order that cellulose acylate film after production hardly takes a yellowish tone and is hardly broken in stretching, the extrusion temperature is preferably in the range from 190° C. to 240° C., more preferably in the range from 195° C. to 235° C., and particularly preferably in the range from 200° C. to 230° C. Furthermore, it is preferable that in the feed part A in the extruder 22, a temperature change of a screw 38 is set within ±1° C. Control of this temperature change becomes possible, for example, by circulating water or oil in the screw 38 and using an aluminum casting heater or a heat-medium heater equipped to a piping 23 that will be described later.

Furthermore, it is preferable that in the feed part A in the extruder 22, a temperature change of a screw 38 is set within ±1° C. Control of this temperature change becomes possible, for example, by circulating water or oil in the screw 38 and using an aluminum casting heater or a heat-medium heater equipped to a piping 23 that will be described later.

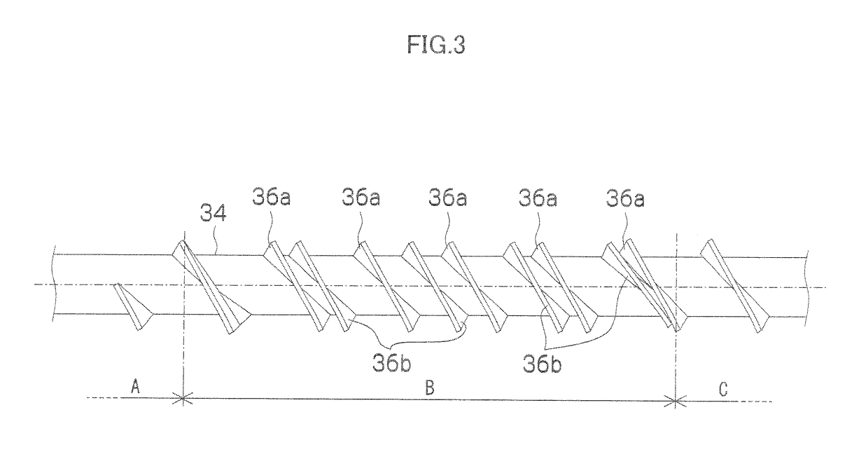

It is preferable that in the compression part B of the extruder 22, the screw 38 is a double flight type as shown in FIG. 3. The double flight type screw 38 is composed such that, in addition to a main flight (screw blade) 36a, a sub-flight 36a is further added to a screw axis 34, and generally, the sub-flight 36b is lower in a depth than that of the main flight 36a, and a pitch thereof is also formed in a large size. Thereby, a resin molten in front of the sub-flight 36b can be separated from the remained, unmolten resin while sending in the rear of the sub-flight 36b, and thus, uniform plasticization of a resin can be intended.

The cellulose acylate film is molten by the extruder 22 that is constituted as described above, and the molten resin is continuously sent to the die 24 (see FIG. 1) from the discharge opening 42 through the piping 23.

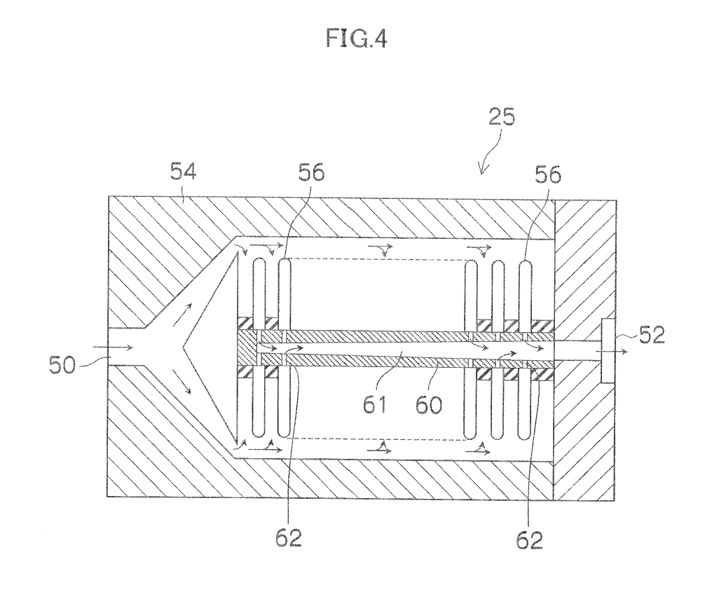

A filtration device 24 is disposed in the piping 23 connecting between the extruder 22 and the die 24 as shown in FIG. 1, FIG. 4 is a schematic view illustrating a structure of the filtration device 25. In addition, it is preferable that the filtration device 25 is disposed in the upstream side than a static mixer 27 that will be described later.

The filtration device 25 is mainly constituted with a filtration housing 45 in a cylindrical shape having a feed opening 50 and a discharge opening 52 of a molten resin, and a plurality of disc-form metallic filtration materials provided in the filtration housing 54 (hereinafter explained in an example of leaf disc filters 56).

The leaf disc filters 56 are fixed in a plural number with one end in the downstream side to a shaft 60 supported and fixed to a surface of an internal wall in the downstream side of the filtration housing 54.

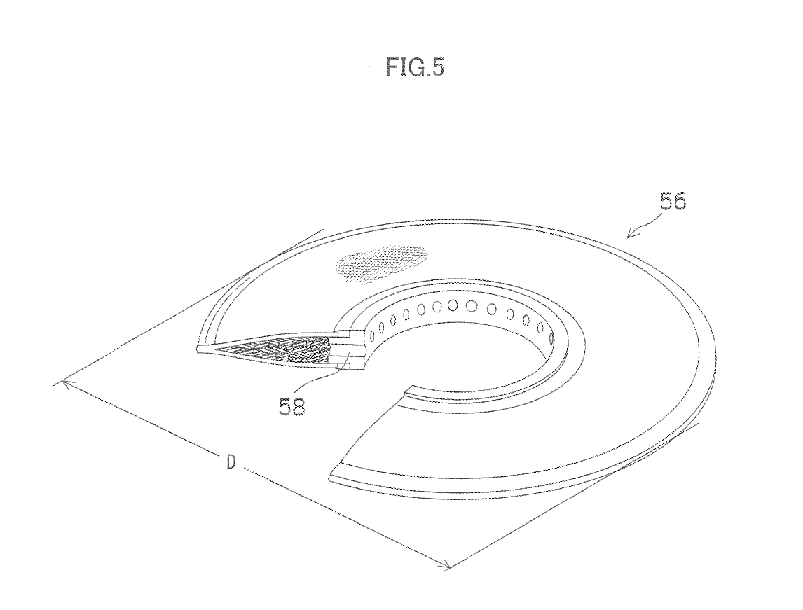

In the shaft 60, a flow path 61 is formed that expands in a diameter toward the downstream, and a connection path 62 (connection hole) that connects a hole 58 (see FIG. 5) formed on an inner circumferential surface of the leaf disc filter 56 described later to a flow path 61 in the shaft 60.

FIG. 5 is a schematic view illustrating the leaf disc filter 56. As shown in FIG. 5, a large number of holes 58 having a pore diameter of 0.1 μm or more and 50 μm or less are formed on the inner circumferential surface of the leaf disc filter 56 so that the molten resin filtered by the leaf disc filter 56 can be taken in the flow path 61. A diameter D of the leaf disc filter 56 and the like are suitably set according to a feed amount of a molten resin from the extruder 22 and a retention time thereof.

Thereby, the molten resin molten in the extruder 22 is fed into the leaf disc filters 56 formed in a disc form from the feed opening 50, and the molten resin filtered in the leaf disc filters 56 passes through the inside of the holes 58 (see FIG. 5). This molten resin flows in the flow path 61 through the connection path 62 in the shaft 60 and is then discharged from the discharge opening 52. Thereby, fine contaminants in the molten resin are removed.

Further, as shown in FIG. 1, a static mixer 27 is disposed in the piping 23. The static mixer 27 in the present embodiment has elements 27a, 27a . . . (static elements) in a form of twisting a rectangular plate at 180°.

The element 27a of the static mixer 27 is formed so as to satisfy ρ×V<2ⁿ×m×V when assumed that a viscosity of the molten resin is ρ(Pa·s), a discharge amount of the molten resin is V (kg/h), the number of the connection paths 62 formed in the shaft 60 is m, and the number of step of the element 27a in the static mixer 27 is n. In the static mixer 27, a kneading amount necessary for removing scratches formed particularly when a molten resin passes through the holes 58 in the leaf disc filters 56 and the connection paths 62 in the shaft 60 is changed depending on a viscosity of the molten resin. Therefore, the static mixer 27 of the present invention is structured so as to have the number of steps of the element 27a suited for the viscosity of the molten resin.

Structuring the static mixer 27 so as to satisfy the above described relationship formula prevents a molten resin from generating heat to cause heat deterioration by excess kneading, and also enables to remove scratches by uniform kneading. Further, by making the elements 27a have m elements or more, the molten resin is divided into 2^{m} or more, and a rotational direction of the molten resin is changed per 1 element and radical inversion of inertial force is received to be turbulently stirred, which thus leads to uniform kneading.

As described above, in melt film formation of the cellulose acylate film 12, the static mixer 27 in which the filtration device 25 and the elements 27a satisfying the above relationship formula are formed in the piping 23 is disposed, and by reducing scratches formed in a molten resin, and temperature unevenness and viscosity unevenness, generation of scratch defect of the film 12 can be suppressed. Thereby, the cellulose acylate film 12 having preferable surface quality without surface defect can be produced.

Further, when the filtration device 25 constituted with leaf disc filters 56 is disposed in the piping 23 connecting between the extruder 22 and the die 24, fine contaminants present in a molten resin can be effectively removed. Further, by disposing the filtration device 25 in the upstream side of the static mixer 27, record of a molten resin flow in the flow path 61 of the shaft 60 and the connection path 62 in the filtration device 25 can be homogenized by the static mixer 27 in the downstream side, and thus, generation of scratch defect of the produced cellulose acylate film 12 can be suppressed.

As shown in FIG. 1, a liquid transfer means is generally disposed between the extruder 22 and the filtration device 25. Known devices can be used as the liquid transfer means, but a gear pump (not shown) is preferably used (details of a gear pump will be described later). By the liquid transfer means, a molten resin can be more uniformly conveyed to the filtration device 25 or the static mixer 27.

As shown in FIG. 1, a linear distance L1 until the molten resin discharged from a discharge opening of the die 24 reaches on the cooling drum 26 (distance between a discharge opening of the die and the cooling support surface) is preferably set at 100 mm or less. Setting within this range enables the molten resin discharged from the die 24 to inhibit cooling during the time until reaching the cooling drum 26 to the minimum, and generation of temperature unevenness or viscosity unevenness in the width direction of a cellulose acylate film is suppressed, which can control generation of retardation (Re) distribution. Herein, the retardation (Re) distribution is a gap between the maximum value and the minimum value. In addition, as described with an example using a casting roll in FIG. 1, but not limited thereto, a molten resin can be pressurized also from the surface thereof by using a touch roll, and surface quality can be further improved.

A temperature of a discharge opening of the die 24 is preferably set at 220° C. or higher, setting a temperature at which the molten resin is not thermally deteriorated as the upper limit (about 230° C.). Temperature control of the molten resin in a discharged opening of the die 24 can be performed by covering the periphery of the die 24 with a jacket not shown, embedding a heater in a lip edge portion of the die 24, heating the molten resin by a heater disposed between the discharge opening of the die 24 and the cooling drum 26, or the like. Thereby, temperature unevenness and viscosity unevenness caused by cooling during the time until the molten resin reaches from the discharge opening of the die 24 to the cooling drum 26 can be suppressed.

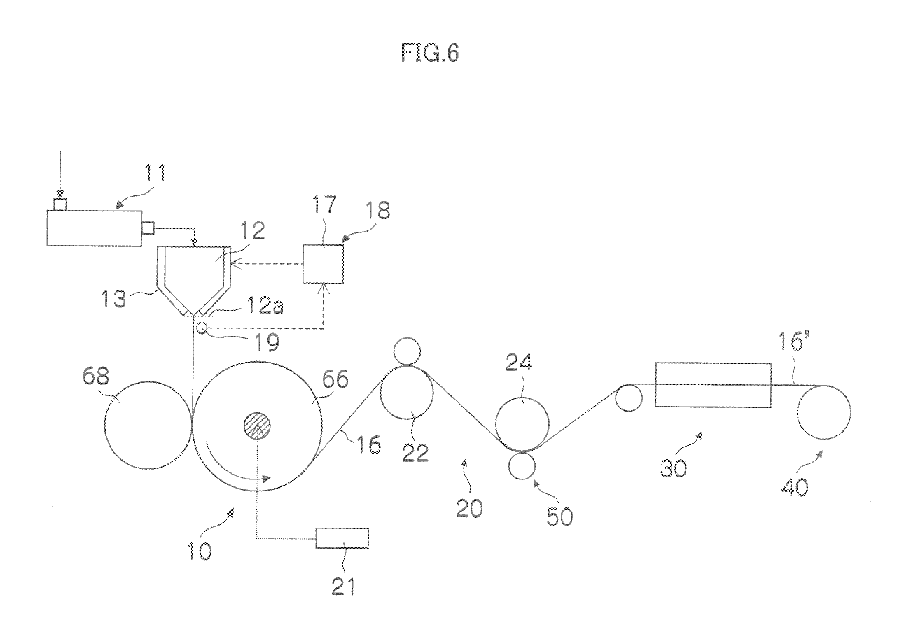

FIG. 1 explained about an example using the casting-type cooling drum 26, but not limited thereto, a touch roll-type cooling roller 66 and a pressing roller 68 as shown in FIG. 6 can be also employed.

As shown in FIG. 5, when a sheet-form molten resin is pinched with a pair of the cooling roller 66 and the pressing roller 68, the pressing roller 68 receives reactive force from the cooling roller 66 through the sheet to deform elastically into a convex shape along with the surface of the cooling roller 44. Thereby, the pressing roller 68 and the cooling roller 66 are in contact with the surface to the molten resin in a feint of a sheet, and simultaneously, by recovery force by which a shape of the elastically deformed pressing roller 66 is recovered to its original shape, the sheet-form molten resin that is pinched is cooled by the cooling roller 66 while being pressed into a surface form.

Further, when a length of a part contacting the pressing roller 68 and the cooling roller 66 through the molten resin is assumed to be Q (cm), and a line pressure at which the pressing roll 68 and the cooling roller 66 pinch the molten resin is assumed to be P (kg/cm), it is preferable to set the line pressure P and the contact part length Q so as to satisfy 3 kg/cm²<P/Q<50 kg/cm². This is because when the P/Q is 3 kg/cm² or less, pressing force to the sheet-form molten resin is too small, and surface state improving effect is small, and when the P/Q is 50 kg/cm² or more, too large pressing force causes generation of residual distortion on the sheet-form molten resin and retardation is easily exhibited. As described above, surface quality can be further improved by solidifying with cooling in a touch roll method.

The cellulose acylate film 12 produced into a film by the film formation process part 14 is stretched in the longitudinal stretching process part 16 and transverse stretching process part 18.

Stretching processes of stretching the cellulose acylate film 12 produced into a film by the film formation process part 14 and producing the stretched cellulose acylate film 12 will be described in the following.

The stretching of the cellulose acylate film 12 is carried out for the purpose of developing the in-plane retardation (Re) and the thicknesswise retardation (Rth) by orienting the molecules in the cellulose acylate film 12. Here, the retardations Re and Rth are derived from the following formulas:

Re(nm)=|n(MD)−n(TD)|×T(nm)

Rth(nm)=|{(n(MD)+n(TD))/2}−n(TH)|×T(nm)

wherein n(MD), n(TD) and n(TH) represent the refractive indexes along the lengthwise, widthwise and thicknesswise directions, respectively, and T represents the thickness given in nm units.

As shown in FIG. 1, the cellulose acylate film 12 is first longitudinally stretched along the lengthwise direction in the longitudinal stretching section 16. In the longitudinal stretching section 16, the cellulose acylate film 12 is preheated, and then wound around two niprolls 28, 30 under the condition that the cellulose acylate film 12 is being heated. The niproll on the exit side 30 conveys the cellulose acylate film 12 at a convey speed faster than the convey speed of the niproll on the entry side 28, and thus the cellulose acylate film 12 is stretched along the longitudinal direction.

A preheating temperature in the longitudinal stretching process part 16 is preferably Tg−40° C. or higher and Tg+60° C. or lower, more preferably Tg−20° C. or higher and Tg+40° C. or lower, and further more preferably Tg or higher and Tg+30° C. or lower. A stretching temperature in the longitudinal stretching process part 16 is preferably Tg or higher and Tg+60° C. or lower, more preferably Tg+2° C. or higher and Tg+40° C. or lower, and further more preferably Tg+5° C. or higher and Tg+30° C. or lower. A stretch magnification in the longitudinal direction is preferably 1.0 time or more and 2.5 times or less, and more preferably 1.1 times or more and 2 times or less.

The longitudinally stretched cellulose acylate film 12 is transferred to the transverse stretching section 18 to be transversely stretched along the widthwise direction. In the transverse stretching section 18, for example, a tenter can be preferably used. With this tenter, both widthwise edges of the cellulose acylate film 12 are gripped with clips to be stretched along the transverse direction. This transverse stretching can further increase the retardation Rth.

Transverse stretching is preferably carried out by using a tenter, and a stretching temperature is preferably Tg or higher and Tg+60° C. or lower, more preferably Tg+2° C. or higher and Tg+40° C. or lower, and further more preferably Tg+4° C. or higher and Tg+30° C. or lower. A stretch magnification is preferably 1.0 time or more and 2.5 times or less, and more preferably 1.1 times or more and 2 times or less. It is also preferable to ease in one of longitudinal and transverse directions after the transverse stretching, or the both directions. Thereby, distribution of a delay phase axis in the width direction can be lessened.

By such stretching treatments, a stretched cellulose acylate film can be obtained. Re of the stretched cellulose acylate film is 0 nm or more and 500 nm or less, preferably 10 nm or more and 400 nm or less, more preferably 15 nm or more and 300 nm or less, and Rth is 0 nm or more and 500 nm or less, preferably 50 nm or more and 400 nm or less, more preferably 70 nm or more and 350 nm or less.

Among the stretched films satisfying the above described conditions, more preferable are the stretched films satisfying the relation Re≦Rth, and furthermore preferable are the stretched films satisfying the relation Re×2≦Rth. For the purpose of realizing such a high Rth and such a low Re, it is preferable to stretch the longitudinally stretched film along the transverse (widthwise) direction, as described above. In other words, the orientation difference between the longitudinal direction and the transverse direction makes the difference of the in-plane retardation (Re), and accordingly, the in-plane orientation (Re) can be made small by reducing the difference between the longitudinal and transverse orientations through the transverse stretching, namely, the stretching along the direction perpendicular to the longitudinal direction, in addition to the longitudinal stretching. In other words, this is because the transverse stretching in addition to the longitudinal stretching increases the area magnification, thus the thickness is decreased and the thicknesswise-direction orientation is increased, and Rth can thereby be increased.

Further, the widthwise and lengthwise fluctuations of Re and Rth each as a function of the position are all made to be preferably 5% or less, more preferably 4% or less and furthermore preferably 3% or less.

The cellulose acylate film 12 after stretching is wound up in a roll form in the wind-up process part 20 in FIG. 1. In this time, a wind-up tension of the cellulose acylate film 12 is preferably set at 0.02 kg/mm² or less. By setting the wind-up tension in such a range, the stretched cellulose acylate film 12 can be wound up without generating retardation distribution in the film.

Hereinafter, detailed description will be made on the cellulose acylate resin suitable for the present invention, the method for processing the cellulose acylate film, and the like, according to the sequence of the procedures.

(1) Plasticizers

A resin for the production of the cellulose acylate film in the present invention is preferably added with a polyhydric alcohol plasticizer. Such a plasticizer decreases the modulus of elasticity, and also has an effect to reduce the crystal content difference between the front side and the back side.

The content of the polyhydric alcohol plasticizer is preferably 2 to 20% by weight in relation to the cellulose acylate. The content of the polyhydric alcohol plasticizer is preferably 2 to 20% by weight, more preferably 3 to 18% by weight, and further more preferably 4 to 15% by weight.

When a content of a polyvalent alcoholic plasticizer is less than 2% by weight, the above described effects cannot be achieved, and on the other hand, when the content is more than 20% by weight, oozing (surface deposition of plasticizer) is generated.

Polyol plasticizers practically used in the present invention include: for example, glycerin-based ester compounds such as glycerin ester and diglycerin ester; polyalkylene glycols such as polyethylene glycol and polypropylene glycol; and compounds in which an acyl group is bound to the hydroxyl group of polyalkylene glycol, all of which are highly compatible with cellulose fatty acid ester and produce remarkable thermoplasticization effect.

Specific examples of glycerin esters include: not limited to, glycerin diacetate stearate, glycerin diacetate palmitate, glycerin diacetate mystirate, glycerin diacetate laurate, glycerin diacetate caprate, glycerin diacetate nonanate, glycerin diacetate octanoate, glycerin diacetate heptanoate, glycerin diacetate hexanoate, glycerin diacetate pentanoate, glycerin diacetate oleate, glycerin acetate dicaprate, glycerin acetate dinonanate, glycerin acetate dioctanoate, glycerin acetate diheptanoate, glycerin acetate dicaproate, glycerin acetate divalerate, glycerin acetate dibutyrate, glycerin dipropionate caprate, glycerin dipropionate laurate, glycerin dipropionate mystirate, glycerin dipropionate palmitate, glycerin dipropionate stearate, glycerin dipropionate oleate, glycerin tributyrate, glycerin tripentanoate, glycerin monopalmitate, glycerin monostearate, glycerin distearate, glycerin propionate laurate, and glycerin oleate propionate. Either any one of these glycerin esters alone or two or more of them in combination may be used.

Of these examples, preferable are glycerin diacetate caprylate, glycerin diacetate pelargonate, glycerin diacetate caprate, glycerin diacetate laurate, glycerin diacetate myristate, glycerin diacetate palmitate, glycerin diacetate stearate, and glycerin diacetate oleate.

Specific examples of diglycerin esters include: not limited to, mixed acid esters of diglycerin, such as diglycerin tetraacetate, diglycerin tetrapropionate, diglycerin tetrabutyrate, diglycerin tetravalerate, diglycerin tetrahexanoate, diglycerin tetraheptanoate, diglycerin tetracaprylate, diglycerin tetrapelargonate, diglycerin tetracaprate, diglycerin tetralaurate, diglycerin tetramystyrate, diglycerin tetramyristylate, diglycerin tetrapalmitate, diglycerin triacetate propionate, diglycerin triacetate butyrate, diglycerin triacetate valerate, diglycerin triacetate hexanoate, diglycerin triacetate heptanoate, diglycerin triacetate caprylate, diglycerin triacetate pelargonate, diglycerin triacetate caprate, diglycerin triacetate laurate, diglycerin triacetate mystyrate, diglycerin triacetate palmitate, diglycerin triacetate stearate, diglycerin triacetate oleate, diglycerin diacetate dipropionate, diglycerin diacetate dibutyrate, diglycerin diacetate divalerate, diglycerin diacetate dihexanoate, diglycerin diacetate diheptanoate, diglycerin diacetate dicaprylate, diglycerin diacetate dipelargonate, diglycerin diacetate dicaprate, diglycerin diacetate dilaurate, diglycerin diacetate dimystyrate, diglycerin diacetate dipalmitate, diglycerin diacetate distearate, diglycerin diacetate dioleate, diglycerin acetate tripropionate, diglycerin acetate tributyrate, diglycerin acetate trivalerate, diglycerin acetate trihexanoate, diglycerin acetate triheptanoate, diglycerin acetate tricaprylate, diglycerin acetate tripelargonate, diglycerin acetate tricaprate, diglycerin acetate trilaurate, diglycerin acetate trimystyrate, diglycerin acetate trimyristylate, diglycerin acetate tripalmitate, diglycerin acetate tristearate, diglycerin acetate trioleate, diglycerin laurate, diglycerin stearate, diglycerin caprylate, diglycerin myristate, and diglycerin oleate. Either any one of these diglycerin esters alone or two or more of them in combination may be used.

Of these examples, diglycerin tetraacetate, diglycerin tetrapropionate, diglycerin tetrabutyrate, diglycerin tetracaprylate and diglycerin tetralaurate are preferably used.

Specific examples of polyalkylene glycols include: not limited to, polyethylene glycols and polypropylene glycols having an average molecular weight of 200 to 1000. Either any one of these examples or two of more of them in combination may be used.

Specific examples of compounds in which an acyl group is bound to the hydroxyl group of polyalkylene glycol include: not limited to, polyoxyethylene acetate, polyoxyethylene propionate, polyoxyethylene butyrate, polyoxyethylene valerate, polyoxyethylene caproate, polyoxyethylene heptanoate, polyoxyethylene octanoate, polyoxyethylene nonanate, polyoxyethylene caprate, polyoxyethylene laurate, polyoxyethylene myristylate, polyoxyethylene palmitate, polyoxyethylene stearate, polyoxyethylene oleate, polyoxyethylene linoleate, polyoxypropylene acetate, polyoxypropylene propionate, polyoxypropylene butyrate, polyoxypropylene valerate, polyoxypropylene caproate, polyoxypropylene heptanoate, polyoxypropylene octanoate, polyoxypropylene nonanate, polyoxypropylene caprate, polyoxypropylene laurate, polyoxypropylene myristylate, polyoxypropylene palmitate, polyoxypropylene stearate, polyoxypropylene oleate, and polyoxypropylene linoleate. Either any one of these examples or two or more of them in combination may be used.

To allow these polyols to fully exert the above described effects, it is preferable to perforin the melt film forming of cellulose acylate under the following conditions. Specifically, in the film formation process where pellets of the mixture of cellulose acylate and polyol are melt in an extruder and extruded through a T-die, it is preferable to set the temperature of the extruder outlet (T2) higher than that of the extruder inlet (T1), and it is more preferable to set the temperature of the die (T3) higher than T2. In other words, it is preferable to increase the temperature with the progress of melting. The reason for this is that if the temperature of the above mixture is rapidly increased at the inlet, polyol is first dissolved and liquefied, and cellulose acylate is brought to such a state that it floats on the liquefied polyol and cannot receive sufficient shear force from the screw, which results in occurrence of insoluble cellulose acylate. In such an insufficiently mixed mixture of polyol and cellulose acylate, polyol, as a plasticizer, cannot exert the above described effects; as a result, the occurrence of the difference between both sides of the melt film after melt extrusion cannot be effectively suppressed. Furthermore, such poorly soluble matter results in a fish-eye-like contaminant after the film formation. Such a contaminant is not observed as a brilliant point even through a polarizing plate, but it is visible on a screen when light is projected into the film from its back side. Fish eyes may cause tailing at the outlet of the die, which results in increased number of die lines.

T1 is preferably in the range of 150 to 200° C., more preferably in the range of 160 to 195° C., and more preferably in the range of 165° C. or higher to 190° C. or lower. T2 is preferably in the range of 190 to 240° C., more preferably in the range of 200 to 230° C., and more preferably in the range of 200 to 225° C. It is most important that such melt temperatures T1, T2 are 240° C. or lower. If the temperatures are higher than 240° C., the modulus of elasticity of the formed film tends to be high. The reason is probably that cellulose acylate undergoes decomposition because it is melted at high temperatures, which causes crosslinking in it, and hence increase in modulus of elasticity of the formed film. The die temperature T3 is preferably 200 to less than 235° C., more preferably in the range of 205 to 230° C., and much more preferably in the range of 205 to 225° C.

(2) Stabilizer

In the present invention, it is preferable to use, as a stabilizer, either phosphite compound or phosphite ester compound, or both phosphite compound and phosphite ester compound. This enables not only the suppression of film deterioration with time, but the improvement of die lines. These compounds function as a leveling agent and get rid of the die lines formed due to the irregularities of the die.

The amount of these stabilizers mixed is preferably 0.005% to 0.5% by weight, more preferably 0.01% to 0.4% by weight, and much more preferably 0.02% to 0.3% by weight of the resin mixture.

(i) Phosphite Stabilizer

Specific examples of preferred phosphite color protective agents include: not limited to, phosphite color protective agents expressed by the following chemical formula (1) to chemical formula (3).

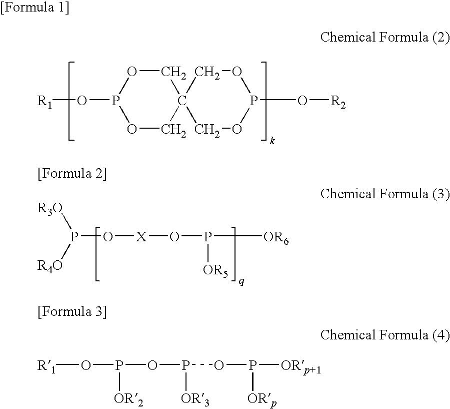

(In the above chemical formulas, R1, R2, R3, R4, R5, R6, R′1, R′2, R′3 . . . R′n, R′n+1 each represent hydrogen or a group selected from the group consisting of alkyl, aryl, alkoxyalkyl, aryloxyalkyl, alkoxyaryl, arylalkyl, alkylaryl, polyaryloxyalkyl, polyalkoxyalkyl and polyalkoxyaryl which have 4 or more and 23 or less carbon atoms. However, for the chemical formulas (2), (3) and (4), all of these functional groups are not simultaneously hydrogen in the same respective formulas. X in the phosphite color protective agents expressed by the chemical formula (3) represents a group selected from the group consisting of aliphatic chain, aliphatic chain with an aromatic nucleus on its side chain, aliphatic chain including an aromatic nucleus in it, and the above described chains including two or more oxygen atoms not adjacent to each other. k and q independently represents an integer of 1 or larger, and p an integer of 3 or larger.)

The k, q in the phosphite color protective agents are preferably 1 to 10. If the k, q are 1 or larger, the agents are less likely to volatilize when heating. If they are 10 or smaller, the agents have an improved compatibility with cellulose acetate propionate. Thus the k, q in the above range are preferable. p is preferably 3 to 10. If the p is 3 or more, the agents are less likely to volatilize when heating. If the p is 10 or less, the agents have improved compatibility with cellulose acetate propionate.

Specific examples of preferred phosphite color protective agents expressed by the chemical formula (general formula) (2) below include phosphite color protective agents expressed by the chemical formulas (5) to (8) below.

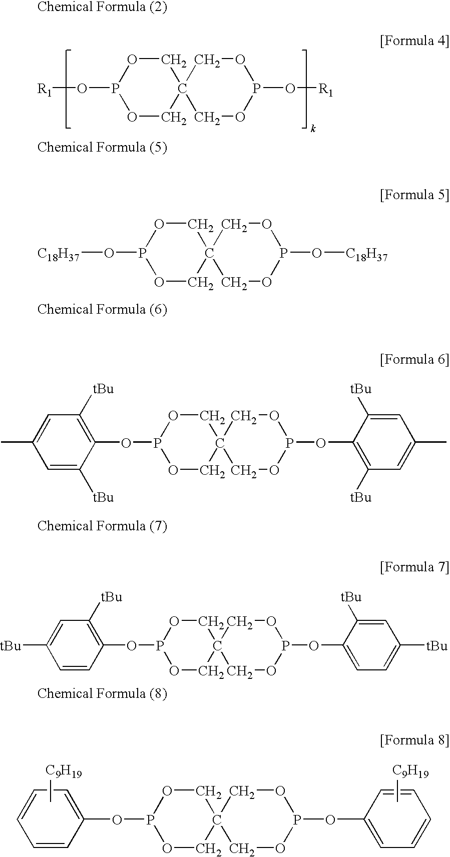

Specific examples of preferred phosphite color protective agents expressed by the chemical formula (general formula) (3) below include phosphite color protective agents expressed by the chemical formulas (9), (10) and (11) below.

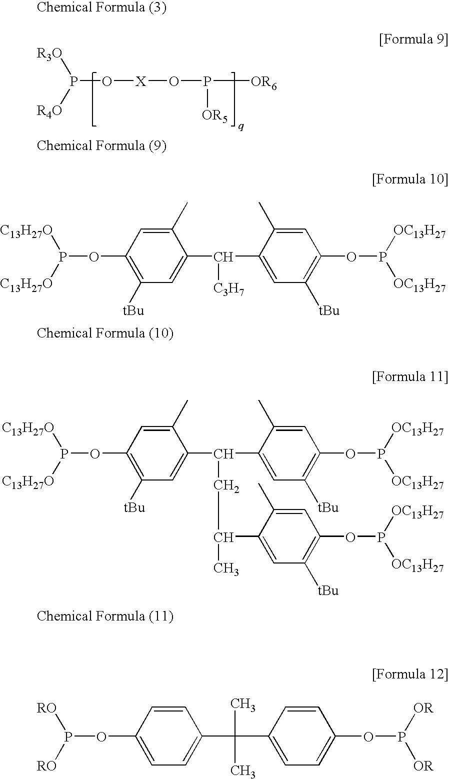

R=alkyl group with 12 to 15 carbon atoms

(ii) Phosphite Ester Stabilizer

Examples of phosphite ester stabilizers include: cyclic neopentane tetraylbis(octadecyl)phosohite, cyclic neopentane tetraylbis(2,4-di-t-butylphenyl)phosohite, cyclic neopentane tetraylbis(2,6-di-t-butyl-4-methylphenyl)phosohite, 2,2-methylene-bis(4,6-di-t-butylphenyeoctylphosphite, and tris(2,4-di-t-butylphenyl)phosphite.

(iii) Other Stabilizers

A weak organic acid, thioether compound, or epoxy compound, as a stabilizer, may be mixed with the resin mixture.

Any weak organic acids can be used as a stabilizer in the present invention, as long as they have a pKa of 1 or more, do not interfere with the action of the present invention, and have color preventive and deterioration preventive properties. Examples of such weak organic acids include: tartaric acid, citric acid, malic acid, fumaric acid, oxalic acid, succinic acid and maleic acid. Either any one of these acids alone or two or more of them in combination may be used.

Examples of thioether compounds include: dilauryl thiodipropionate, ditridecyl thiodipropionate, dimyristyl thiodipropionate, distearyl thiodipropionate, and palmityl stearyl thiodipropionate. Either any one of these compounds alone or two or more of them in combination may be used.

Examples of epoxy compounds include: compounds derived from epichlorohydrin and bisphenol A. Derivatives from epichlorohydrin and glycerin or cyclic compounds such as vinyl cyclohexene dioxide or 3,4-epoxy-6-methylcyclohexylmethyl-3,4-epoxy-6-methylcyclohexane carboxylate can also be used. Epoxydized soybean oil, epoxydized castor oil or long-chain-α-olefin oxides can also be used. Either any one of these compounds alone or two or more of them in combination may be used.

(3) Cellulose Acylate

<<Cellulose Acylate Resin>>

(Composition, Degree of Substitution)

A cellulose acylate that satisfies all of the requirements expressed by the following formulas (1) to (3) is preferably used in the present invention.

2.0≦X+Y≦3.0 formula (1)

0≦X≦2.0 formula (2)

1.2≦Y≦2.9 formula (3)

(In the above formulas (1) to (3), X represents the substitution degree of acetate group and Y represents the sum of the substitution degrees of propionate group, butyrate group, pentanoyl group and hexanoyl group.)

A cellulose acylate that satisfies all of the requirements expressed by the following formulas (4) to (6) is more preferably used in the present invention.

2.4≦X+Y≦3.0 formula (4)

0.05≦X≦1.8 formula (5)

1.3≦Y≦2.9 formula (6)

A cellulose acylate that satisfies all of the requirements expressed by the following formulas (7) to (9) is still more preferably used in the present invention.

2.5≦X+Y≦2.95 formula (7)

0.1≦X≦1.6 formula (8)

1.4≦Y≦2.9 formula (9)

As described above, it is a feature to introduce a propionate group, a butylate group, a pentanoyl group and a hexanoyl group in cellulose acylate. Setting the substitution degree in such a range is preferable since a melting temperature can be lowered, and thus, heat decomposition accompanying by molten film formation can be suppressed. On the other hand, the substitution degree out of this range is not preferable since a modulus of elasticity is out of the range of the present invention.

Either any one of the above cellulose acylates alone or two or more of them in combination may be used. A cellulose acylate into which a polymeric ingredient other than cellulose acylate has been properly mixed may also be used.

In the following a process for producing the cellulose acylate according to the present invention will be described in detail. The raw material cotton for the cellulose acylate according to the present invention or process for synthesizing the same are described in detail in Journal of Technical Disclosure (Laid-Open No. 2001-1745, issued on Mar. 15, 2001, Japan Institute of Invention and Innovation), pp. 7-12.

(Raw Materials and Pretreatment)

As a raw material for cellulose, one from broadleaf pulp, conifer pulp or cotton linter is preferably used. As a raw material for cellulose, a material of high purity whose α-cellulose content is 92% by mass or higher and 99.9% by mass or lower is preferably used.

When the raw material for cellulose is a film-like or bulk material, it is preferable to crush it in advance, and it is preferable to crush the material to such a degree that the cellulose is in the form of fluff.

(Activation)

Preferably, the cellulose material undergoes treatment, prior to acylation, where it is brought into contact with an activator (activation). Carboxylic acid or water can be used as an activator, and when water is used, it is preferable to include steps such as performing dehydration by excessively adding acid anhydride after activation, washing with carboxylic acid in order to replace water, and adjusting acylation conditions. The activator may be added after adjusting at any temperature, and an addition method can be selected from methods such as spraying, dropping, and immersion.

Carboxylic acids preferably used as an activator are those having 2 or more and 7 or less carbon atoms (e.g. acetic acid, propionic acid, butyric acid, 2-methylpropionic acid, valeric acid, 3-methylbutyric acid, 2-methylbutyric acid, 2,2-dimethylpropionic acid (pivalic acid), hexanoic acid, 2-methylvaleric acid, 3-methylvaleric acid, 4-methylvaleric acid, 2,2-dimethylbutyric acid, 2,3-dimethylbutyric acid, 3,3-dimethylbutyric acid, cyclopentanecarboxylic acid, heptanoic acid, cyclohexanecarboxylic acid and benzoic acid), more preferably acetic acid, propionic acid and butyric acid, and particularly preferably acetic acid.

In activation, an enzyme of acylation such as sulfuric acid can be further added according to necessity. However, when a strong acid such as sulfuric acid is added, since depolymerization may be promoted, the addition amount is preferably kept at about 0.1% by mass to 10% by mass based on cellulose. Further, two kinds or more of activators may be used in combination, or acid anhydride of carboxylic acid having 2 or more and 7 or less carbon atoms may be added.

An addition amount of the activator is preferably 5% by mass or more based on cellulose, more preferably 10% by mass or more, and particularly preferably 30% by mass or more. An amount of the activator of the lower limit value or more is preferable since defect such as lowering a degree of activation of cellulose is not generated. An upper limit of the addition amount of the activator is not particularly limited as long as productivity is not lowered, and the addition amount is preferably 100 times or less by mass based on cellulose, more preferably 20 times or less, and particularly preferably 10 times or less. The activator is excessively added for cellulose to perform activation, and then, an amount of the activator may be decreased by carrying out operations such as filtration, air drying, heat drying, distillation in reduced pressure, solvent substitution, and the like.

A time of activation is preferably 20 minutes or longer, and an upper limit is not particularly limited as long as it does not give an adverse effect on productivity, and is preferably 72 hours or shorter, more preferably 24 hours or shorter, and particularly preferably 12 hours or shorter. In addition, a temperature of activation is preferably 0° C. or higher and 90° C. or lower, more preferably 15° C. or higher and 80° C. or lower, and particularly preferably 20° C. or higher and 60° C. or lower. A step of activation of cellulose can be also carried out under pressurized or reduced pressure condition. Further, electromagnetic waves such as micro waves or infrared rays may be used as heating means.

(Acylation)

In the method of producing cellulose acylate in the present invention, it is preferable to acylate a hydroxyl group of cellulose by adding acid anhydride of carboxylic acid to cellulose and reacting with a Bronsted acid or a Lewis acid as a catalyst.

As a method for obtaining a cellulose mixed acylate, any one of the methods can be used in which two kinds of carboxylic anhydrides, as acylating agents, are added in the mixed state or one by one to react with cellulose; in which a mixed acid anhydride of two kinds of carboxylic acids (e.g. acetic acid-propionic acid-mixed acid anhydride) is used; in which a carboxylic acid and an acid anhydride of another carboxylic acid (e.g. acetic acid and propionic anhydride) are used as raw materials to synthesize a mixed acid anhydride (e.g. acetic acid-propionic acid-mixed acid anhydride) in the reaction system and the mixed acid anhydride is reacted with cellulose; and in which first a cellulose acylate whose substitution degree is lower than 3 is synthesized and the remaining hydroxyl group is acylated using an acid anhydride or an acid halide.

(Acid Anhydride)

An acid anhydride of carboxylic acid is preferably carboxylic acid having 2 or more and 7 or less carbon atoms, and examples thereof include anhydrous acetic acid, propionic anhydride, butylic anhydride, 2-methylpropionic anhydride, valeric anhydride, 3-methylbutyric anhydride, 2-methylbutylic anhydride, 2,2-dimethylpropionic anhydride (pivalic anhydride), hexanoic anhydride, 2-methylvaleric anhydride, 3-methylvaleric anhydride, 4-methylvaleric anhydride, 2,2-dimethylbutylic anhydride, 2,3-dimethylbutylic anhydride, 3,3-dimethylbutylic anhydride, cyclopentanecarboxylic anhydride, heptanoic anhydride, cyclohexanecarboxylic anhydride, and benzoic anhydride. More preferable examples include anhydrides such as anhydrous acetic acid, propionic anhydride, butylic anhydride, valeric anhydride, hexanoic anhydride, and heptanoic anhydride, and particularly preferable examples include anhydrous acetic acid, propionic anhydride, and butylic acid anhydride.

For the purpose of preparing a mixed ester, it is preferably carried out to use these acid anhydrides in combination. The mixing ratio is preferably determined according to a substitution ratio of a desired mixing ester. An acid anhydride is generally added in an excess equivalent amount based on cellulose. That is, the acid anhydride is preferably added in an amount of 1.2 to 50 equivalent based on a hydroxyl group of cellulose, more preferably in an amount of 1.5 to 30 equivalent, and particularly preferably added in an amount of 2 to 10 equivalent.

(Catalyst)

For a catalyst of acylation used in production of cellulose acylate of the present invention, a Bronsted acid or Lewis acid is preferably used. The definitions of the Bronsted acid and Lewis acid are described, for example, in “the Rikagaku Jiten (The Dictionary of Physics and Chemistry)”, Vol. 5 (2000). Preferable examples of the Bronsted acid include sulfuric acid, perchloric acid, phosphoric acid, methanesulfonic acid, benzenesulfonic acid, and p-toluenesulfonic acid. Preferable examples of the Lewis acid include zinc chloride, tin chloride, antimony chloride, and magnesium chloride.

As the catalyst, sulfuric acid and perchloric acid are preferable, and sulfuric acid is particularly preferable. The amount of the catalyst added is preferably 0.1 to 30% by mass of the amount of cellulose, more preferably 1 to 15% by mass, and particularly preferably 3 to 12% by mass.

(Solvent)

When carrying out acylation, a solvent may be added to the reaction mixture so as to adjust the viscosity, reaction speed, ease of stirring or acyl substitution ratio of the reaction mixture. As such a solvent, dichloromethane, chloroform, carboxylic acid, acetone, ethyl methyl ketone, toluene, dimethylsulfoxide, sulfolane, and the like can be also used, but a preferable solvent is carboxylic acid, and examples thereof include carboxylic acids having 2 or more and 7 or less carbon atoms (e.g., acetic acid, propionic acid, butylic acid, 2-methylpropionic acid, valeric acid, 3-methylbutyric acid, 2-methylbutylic acid, 2,2-dimethylpropionic acid (pivalic acid), hexanoic acid, 2-methylvaleric acid, 3-methylvaleric acid, 4-methylvaleric acid, 2,2-dimethylbutylic acid, 2,3-dimethylbutylic acid, 3,3-dimethylbutylic acid, and cyclopentanecarboxylic acid). More preferable examples include acetic acid, propionic acid and butylic acid. These solvents may be used in combination.

(Acylation Conditions)

The acylation may be carried out in such a manner that a mixture of acid anhydride(s), catalyst and, if necessary, solvent(s) is prepared first and then the mixture is mixed with cellulose, or acid anhydride(s), catalyst and, if necessary, solvent(s) are mixed with cellulose one after another. Generally, it is preferable that a mixture of acid anhydride(s) and catalyst or a mixture of acid anhydride(s), catalyst and solvent(s) is prepared first and then the mixture, as an acylating agent, is reacted with cellulose. To suppress the temperature increase in the reactor due to the heat of reaction generated in the acylation, it is preferable to cool such an acylating agent in advance. A cooling temperature is preferably −50° C. to 20° C., more preferably −35° C. to 10° C., and particularly preferably −25° C. to 5° C. An acylating agent may be added in a liquid state, or may be added as a solid in a form of a crystal, flake, or block by freezing.

Acylating agent(s) may be added to cellulose at one time or in installments. Or cellulose may be added to acylating agent(s) at one time or in installments. When the acylating agent is added dividedly, acylating agents with the same composition may be used, or acylating agents with a plurality of different compositions may be used. As preferable examples are described, 1) a mixture of an acid anhydride and a solvent is first added and then a catalyst is added, 2) a mixture of an acid anhydride, and a part of a solvent and a catalyst is first added and then a mixture of the remainings of the catalyst and the solvent are added, 3) a mixture of an acid anhydride and a solvent is first added and then a mixture of a catalyst and a solvent is added, 4) a solvent is first added, and a mixture of an acid anhydride and a catalyst or a mixture of an acid anhydride, a catalyst and a solvent is added, and the like.

Acylation of cellulose is a heat generation reaction, and in the method for producing cellulose acylate of the present invention, a highest reaching temperature in acylation is preferably 50° C. or lower. The reaction temperature of this temperature or lower is preferable because of not generating defect such that depolymerization proceeds and cellulose acylate having a polymerization degree suitable for uses of the present invention is hardly obtained. The highest reaching temperature in acylation is preferably 45° C. or lower, more preferably 40° C. or lower, and particularly preferably 35° C. or lower. The reaction temperature may be controlled by using a temperature controller, or may be controlled at an initial temperature of an acylating agent. A reaction container is depressurized, and the reaction temperature can be controlled by evaporation heat of a liquid component in the reaction system. Since heat generation in acylation is large at an initial stage of the reaction, the temperature is cooled in the reaction initial stage and then can be controlled by heating, and the like. A termination point of acylation can be determined by a light lay transmittance, a solution viscosity, a temperature change in the reaction system, solubility of a reaction product to an organic solvent, and a means such as polarization microscope observation.

A lowest temperature of the reaction is preferably −50 C. ° or higher, more preferably −30 C. ° or higher, particularly preferably −20 C. ° or higher. An acylation time is preferably 0.5 hour or longer and 24 hours or shorter, more preferably 1 hour or longer and 12 hours or shorter, and particularly preferably 1.5 hours or longer and 6 hours or shorter. The acylation time of 0.5 hour or shorter is not preferable since a reaction does not sufficiently proceed under general reaction conditions, and the acylation time of exceeding 24 hours is not preferable for industrial production.

(Reaction Terminator)

In the method for producing a cellulose acylate used in the present invention, it is preferable to add a reaction terminator after the acylation reaction.

Any reaction terminator may be used, as long as it can decompose acid anhydride(s). Examples of preferred reaction terminators include: water, alcohols (e.g. ethanol, methanol, propanol and isopropyl alcohol), and compositions including the same. In addition, a reaction terminator may contain neutralizers described later. In adding the reaction terminator, in order to avoid defects such that large heat generation exceeding cooling ability of a reaction device is caused, resulting in being a factor of lowering a polymerization degree of cellulose acylate, and cellulose acylate may be precipitated in an undesired form, it is preferable to add a mixture of carboxylic acid such as acetic acid, propionic acid and butylic acid, and water, rather than directly adding water and an alcohol, and acetic acid is particularly preferable as carboxylic acid. A blending ratio of carboxylic acid and water can be at any ratio to be used, and a water content is preferably in the range from 5% by mass to 80% by mass, more preferably from 10% by mass to 60% by mass, and particularly preferably from 15% by mass to 50% by mass.

The reaction terminator may be added in a reaction container of acylation, or a reaction mixture may be added to a container of the reaction terminator. The reaction terminator is preferably added over 3 minutes to 3 hours. Taking 3 minutes or longer to add the reaction terminator is preferable since there causes no defects such that heat generation becomes too large, which results in being a factor of lowering of a polymerization degree, hydrolysis of acid anhydride is insufficient, or stability of cellulose acylate is reduced. Further, taking 3 hours or shorter to add the reaction terminator is preferable since a problem such as lowering of industrial productivity is not caused. A time of adding the reaction terminator is preferably 4 minutes or longer and 2 hours or shorter, more preferably 5 minutes or longer and 1 hour or shorter, and particularly preferably 10 minutes or longer and 45 minutes or shorter. When the reaction terminator is added, a reaction container may or may not be cooled, but for the purpose of suppressing depolymerization, it is preferable to cool a reaction container so as to suppress temperature increase. In addition, it is also preferable to cool the reaction terminator.

(Neutralizer)

In order to hydrolyze excess anhydrous carboxylic acid remained in a system and neutralize a part or all of carboxylic acid and esterifying catalyst during the step of terminating an acylation reaction or after the step of terminating an acylation reaction, neutralizers (for example, carbonate, acetate, hydroxide or oxide of calcium, magnesium, iron, aluminum or zinc) or solutions thereof may be added. Preferable examples of solvents of the neutralizer include polar solvents such as water, alcohols (e.g., ethanol, methanol, propanol, and isopropyl alcohol), carboxylic acid (e.g., acetic acid, propionic acid, and butylic acid), ketone (e.g., acetone and ethyl methyl ketone), and dimethylsulfoxide, and mixed solvents thereof.

(Partial Hydrolysis)

In the cellulose acylate thus obtained, the sum of the substitution degrees is approximately 3. Then, to obtain a cellulose acylate with desired substitution degree, generally the obtained cellulose acylate is kept at 20 to 90° C. in the presence of a small amount of catalyst (generally acylating catalyst such as remaining sulfuric acid) and water for several minutes to several days so that the ester linkage is partially hydrolyzed and the substitution degree of the acyl group of the cellulose acylate is decreased to a desired degree (so called aging). Since sulfuric acid ester of cellulose is also hydrolyzed in a process of partial hydrolysis, an amount of sulfuric acid ester bonded to cellulose can be reduced by adjusting the hydrolysis condition.

Preferably, the catalyst remaining in the reaction system is completely neutralized with a neutralizer as described above or the solution thereof at the time when a desired cellulose acylate is obtained so as to terminate the partial hydrolysis. It is also preferable to add a neutralizer which forms a salt slightly soluble in the reaction solution (e.g. magnesium carbonate and magnesium acetate) to effectively remove the catalyst (e.g. sulfuric ester) in the solution or bound to the cellulose.

(Filtration)

To remove the unreacted matter, slightly soluble salts or other contaminants in the cellulose acylate or to reduce the amount thereof, it is preferable to filter the reaction mixture (dope). The filtration may be carried out in any step after the completion of acylation and before the reprecipitation of the same. To control the filtration pressure or the handleability of the cellulose acylate, it is preferable to dilute the cellulose acylate with an appropriate solvent prior to filtration.

(Reprecipitation)

An intended cellulose acylate can be obtained by: mixing the cellulose acylate solution thus obtained into a poor solvent, such as water or an aqueous solution of a carboxylic acid (e.g. acetic acid and propionic acid), or mixing such a poor solvent into the cellulose acylate solution, to precipitate the cellulose acylate; washing the precipitated cellulose acylate; and subjecting the washed cellulose acylate to stabilization treatment. The reprecipitation may be performed continuously or in a batchwise operation. It is also preferable to control a form of reprecipitated cellulose acylate or a molecular weight distribution by adjusting a concentration of the cellulose acylate solution and a composition of a poor solvent by a substitution manner or a polymerization degree of cellulose acylate.

(Washing)

It is preferable that produced cellulose acylate is subjected to a washing treatment. Any washing solvent may be preferable as long as it has low solubility to cellulose acylate and can remove impurities, but water or warm water is generally used. A temperature of washing water is preferably 25° C. to 100° C., more preferably 30° C. to 90° C., and particularly preferably 40° C. to 80° C. The washing treatment may be carried out in, so-called, a batch method in which filtration and exchange of washing solutions are repeated, or may be performed using a continuous washing device. It is also preferable that a waste liquid generated in steps of reprecipitation and washing is reused as a poor solvent in the reprecipitation step, or a solvent such as carboxylic acid is recovered by a means such as distillation to be reused.

Progress of washing may be tracked by any means, and preferable examples include methods such as hydrogen ion concentration, ion chromatography, electric conductivity, ICP, element analysis, and atomic absorption spectrum.

Due to such a treatment, catalysts (e.g., sulfuric acid, perchloric acid, trifluoroacetic acid, p-toluenesulfonic acid, methanesulfonic acid, and zinc chloride), neutralizers (e.g., carbonate, acetate, hydroxide or oxide of calcium, magnesium, iron, aluminum or zinc), a reaction product of a neutralizer and a catalyst, carboxylic acid (e.g., acetic acid, propionic acid, and butylic acid), a reaction product of a neutralizer and carboxylic acid, and the like in cellulose acylate can be removed, and this removal is effective for enhancing stability of cellulose acylate.

(Stability)

Cellulose acylate after washing by a warm water treatment is also preferably treated with an aqueous solution of a weak alkali (for example, carbonate, hydrogen carbonate, hydroxide, oxide, and the like of sodium, potassium, calcium, magnesium, aluminum etc.) in order to further improve stability or lower odor of carboxylic acid.

An amount of residual impurities can be controlled by an amount of washing liquid, a temperature, a time and a stirring method of washing, a shape of a washing container, and a composition and a concentration of a stabilizer. In the present invention, conditions of acylation, hydrolysis and washing are set so that a residual sulfuric acid ion amount (as a content of sulfur atoms) is 0 to 500 ppm.

(Drying)

In order to adjust a moisture content of cellulose acylate to a preferable amount in the present invention, it is preferable to dry cellulose acylate. A method of drying is not particularly limited as long as a desired moisture content is obtained, and it is preferable to effectively perform drying by using means such as heating, air blasting, depressurizing, and stirring alone or in combination. The drying temperature is preferably 0 to 200° C., more preferably 40 to 180° C., and particularly preferably 50 to 160° C. The water content of the cellulose acylate of the present invention is preferably 2% by mass or less, more preferably 1% by mass or less, and particularly preferably 0.7% by mass or less.

(Form)

The cellulose acylate of the present invention can take various forms, such as particle, powder, fiber and bulk forms. However, as a raw material for films, the cellulose acylate is preferably in the particle form or in the powder form. Thus, the cellulose acylate after drying may be crushed or sieved to make the particle size uniform or improve the handleability. When the cellulose acylate is in the particle form, preferably 90% by mass or more of the particles used has a particle size of 0.5 to 5 mm Further, preferably 50% by mass or more of the particles used has a particle size of 1 to 4 mm. Preferably, the particles of the cellulose acylate have a shape as close to a sphere as possible. And the apparent density of the cellulose acylate particles of the present invention is preferably 0.5 to 1.3, more preferably 0.7 to 1.2, and particularly preferably 0.8 to 1.15. The method for measuring the apparent density is specified in JIS K-7365.

The cellulose acylate particles of the present invention preferably have an angle of repose of 10 to 70 degrees, more preferably 15 to 60 degrees, and particularly preferably 20 to 50 degrees.

(Degree of Polymerization)

The average degree of polymerization of the cellulose acylate preferably used in the present invention is 100 to 300, preferably 120 to 250, and much more preferably 130 to 200. The average degree of polymerization can be determined by intrinsic viscosity method by Uda et al. (Kazuo Uda and Hideo Saitoh, Journal of the Society of Fiber Science and Technology, Japan, Vol. 18, No. 1, 105-120, 1962) or by the molecular weight distribution measurement by gel permeation chromatography (GPC). The determination of average degree of polymerization is described in detail in Japanese Patent Application Laid-Open No. 9-95538.

In the present invention, a weight average polymerization degree/number average polymerization degree of cellulose acylate by GPC is preferably 1.6 to 3.6, more preferably 1.7 to 3.3, and particularly preferably 1.8 to 3.2.

Only one kind of these cellulose acylates may be used, and two or more kinds thereof may be used in combination. Further, a polymer component other than cellulose acylate, which is suitably mixed, may be used. A polymer component to be mixed preferably has excellent compatibility with a cellulose ester, and a transmittance at the time of forming into a film is 80% or more, more preferably 90% or more, and further more preferably 92% or more.

### SYNTHESIS EXAMPLES OF CELLULOSE ACYLATE

Synthesis examples of cellulose acylate used in the present invention will be more specifically described in the following, but the present invention is not limited thereto.

### Synthesis Example 1

### Synthesis of Cellulose Acetate Propionate

150 g of cellulose (broad leaf pulp) and 75 g of acetic acid were placed into a reaction container, a 5 L-separable flask equipped with a reduction device, and intensively stirred for 2 hours while heating in an oil bath adjusted to 60° C. The cellulose subjected to such a pretreatment was swollen and decomposed to become a fluff state. The reaction container was placed in an ice water bath at 2° C. for 30 minutes to be cooled.

Separately, a mixture of 1545 g of propionic acid anhydride and 10.5 g of sulfuric acid was prepared as an acylating agent and cooled to −30° C., and then added to the reaction container storing the cellulose subjected to the above described pretreatment at once. After elapse of 30 minutes, an external temperature was gradually increased and adjusted so that an internal temperature was 25° C. after elapsing 2 hours from addition of the acylating agent. The reaction container was cooled in an ice water bath at 5° C., and adjusted so that the internal temperature becomes 10° C. after 0.5 hour from addition of the acylating agent and the internal temperature becomes 23° C. after 2 hours, and the reaction mixture was stirred for further 3 hours while keeping the internal temperature at 23° C. The reaction container was cooled in an ice water bath at 5° C. and thereto was added 120 g of 25% (by mass)-water-containing acetic acid over 1 hour. The internal temperature was increased to 40° C., and the reaction mixture was stirred for 1.5 hours. Then, a solution in which magnesium acetate tetraanhydrate is dissolved in 50% (by mass)-water-containing acetic acid in an amount of 2-hold moles of sulfuric acid was added to the reaction container and the reaction mixture was stirred for 30 minutes. Thereto were added 1 L of 25% (by mass)-water-containing acetic acid, 500 mL of 33% (by mass)-water-containing acetic acid, 1 L of 50% (by mass)-water-containing acetic acid, and 1 L of water in this order, and cellulose acetate propionate was precipitated. The obtained precipitate of cellulose acetate propionate was washed with warm water. By changing the washing conditions in this time, cellulose acetate propionate changed in a residual sulfuric acid ion amount was obtained. After washing, the cellulose acylate propionate was stirred in an aqueous solution of 0.005% by mass of calcium hydroxide for 0.5 hour, and further washed with water until the pH of the washing solution was 7, and then dried in vacuum at 70° C.

According to 1H-NMR and GPC measurement, the obtained cellulose acetate propionate had an acetylation degree of 0.30, a propionylation degree of 2.63, and a polymerization degree of 320. A content of a sulfuric acid ion was measured by ASTM D-817-96.

### Synthesis Example 2

### Synthesis of Cellulose Acetate Butylate

100 g of cellulose (broad leaf pulp) and 135 g of acetic acid were placed into a reaction container, a 5 L-separable flask equipped with a reduction device, and left for 1 hour while heating in an oil bath adjusted at 60° C. Then, the reaction mixture was intensively stirred for 1 hour while heating in an oil bath adjusted at 60° C. The cellulose subjected to such a pretreatment was swollen and decomposed to become a fluff state. The reaction container was placed in an ice water bath at 5° C. for 1 hour to sufficiently cool the cellulose.

Separately, a mixture of 1080 g of butylic anhydride and 10.0 g of sulfuric acid was prepared as an acylating agent and cooled to −20° C., and then added to the reaction container storing cellulose subjected to the above described pretreatment at once. After elapse of 30 minutes, an external temperature was increased to 20° C. and reacted for 5 hours. The reaction container was cooled in an ice water bath at 5° C. and thereto was added 2400 g of 12.5% (by mass)-water-containing acetic acid cooled at about −5° C. over 1 hour. The internal temperature was increased to 30° C., and the reaction mixture was stirred for 1 hour. Then, 100 g of an aqueous solution containing 50% by mass of magnesium acetate tetraanhydrate was added to the reaction container and the reaction mixture was stirred for 30 minutes. Thereto were gradually added 1000 g of acetic acid and 2000 g of 50% by mass water containing-acetic acid, and cellulose acetate butylate was precipitated. The obtained precipitate of cellulose acetate butylate was washed with warm water. By changing the washing conditions in this time, cellulose acetate butylate changed in a residual sulfuric acid ion amount was obtained. After washing, the cellulose acetate butylate was stirred in an aqueous solution containing 0.005% by mass of calcium hydroxide for 0.5 hour, and further washed with water until the pH of the washing solution was 7, and then dried at 70° C. The obtained cellulose acetate butylate had an acetylation degree of 0.84, a butylylation degree of 2.12, and a polymerization degree of 268.

(4) Other Additives

(i) Matting Agent

Preferably, fine particles are added as a matting agent. Examples of fine particles used in the present invention include: those of silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate and calcium phosphate. Fine particles containing silicon are preferable because they can decrease the turbidity of the cellulose acylate film. Fine particles of silicon dioxide are particularly preferable. Preferably, the fine particles of silicon dioxide have an average primary particle size of 20 nm or less and an apparent specific gravity of 70 g/liter or more. Those having an average primary particle size as small as 5 to 16 nm are more preferable, because they enable the haze of the film produced to be decreased. The apparent specific gravity is preferably 90 to 200 g/liter or more and more preferably 100 to 200 g/liter or more. The larger the apparent specific gravity, the more preferable, because fine particles of silicon dioxide having a larger apparent specific gravity make it possible to prepare a dispersion of higher concentration, thereby improving the haze and the agglomerates.

These fine particles generally form secondary particles having an average particle size of 0.1 to 3.0 μm, which exist as agglomerates of primary particles in a film and form irregularities 0.1 to 3.0 μm in size on the film surface. The average secondary particle size is preferably 0.2 μm or more and 1.5 μm or less, more preferably 0.4 μm or more and 1.2 μm or less, and most preferably 0.6 μm or more and 1.1 μm or less. The primary particle size and the secondary particle size are determined by observing the particles in the film with a scanning electron microscope and using the diameter of the circle circumscribing each particle as a particle size. The average particle size is obtained by averaging the 200 determinations resulting from observation at different sites.

As fine particles of silicon dioxide, those commercially available, such as Aerosil R972, R972V, R974, R812, 200, 200V, 300, R202, OX50 and TT600 (manufactured by Nippon Aerosil Co., LTD), can be used. As fine particles of zirconium oxide, those on the market under the trade name of Aerosil R976 and R811 (manufactured by Nippon Aerosil Co., LTD) can be used.

Of these fine particles, Aerosil 200V and Aerosil R972V are particularly preferable, because they are fine particles of silicon dioxide having an average primary particle size of 20 nm or less and an apparent specific gravity of 70 g/liter more and they produce a large effect of reducing friction coefficient of the optical film produced while keeping the turbidity of the same low.

(ii) Other Additives

Various additives other than the above described matting agent, such as ultraviolet light absorbers (e.g. hydroxybenzophenone compounds, benzotriazole compounds, salicylate ester compounds and cyanoacrylate compounds), infrared absorbers, optical adjustors, surfactants and odor-trapping agents (e.g. amine), can be added to the cellulose acylate of the present invention. The materials preferably used are described in detail in Journal of Technical Disclosure Laid-Open No. 2001-1745 (issued on Mar. 15, 2001, Japan Institute of Invention and Innovation), pp. 17-22.

As infrared absorbers, for example, those described in Japanese Patent Application Laid-Open No. 2001-194522 can be used, while as ultraviolet light absorbers, for example, those described in Japanese Patent Application Laid-Open No. 2001-151901 can be used. Both the infrared absorber content and the ultraviolet light absorber content of the cellulose acylate are preferably 0.001 to 5% by mass.

Examples of optical adjustors include retardation adjustors. And those described in, for example, Japanese Patent Application Laid-Open Nos. 2001-166144, 2003-344655, 2003-248117 and 2003-66230 can be used. The use of such a retardation adjustor makes it possible to control the in-plane retardation (Re) and the retardation across the thickness (Rth) of the film produced. Preferably, the amount of the retardation adjustor added is 0 to 10 wt %, more preferably 0 to 8 wt %, and much more preferably 0 to 6 wt %.

(5) Physical Properties of Cellulose Acylate Mixture

The above described cellulose acylate mixtures (mixtures of cellulose acylate, plasticizer, stabilizer and other additives) preferably satisfy the following physical properties.

(i) Weigh Loss

The thermoplastic cellulose acetate propionate composition of the present invention has a loss in weight on heating at 220° C. of 5% by weight or less. The term “loss in weight on heating” herein used means the loss in weight at 220° C. of a sample when the temperature of the sample is increased from room temperature at a temperature increasing rate of 10° C./min in an atmosphere of nitrogen gas. The loss in weight on heating of cellulose acylate can be 5% by weight or less by preparing the above described cellulose acylate mixture. The loss in weight on heating of a cellulose acylate mixture is more preferably 3% by weight or less and much more preferably 1% by weight or less. Keeping the loss in weight on heating of a cellulose acylate mixture in the above described range makes it possible to suppress the trouble occurring in the film formation (generation of air bubbles).

(ii) Melt Viscosity

For the thermoplastic cellulose acetate propionate composition of the present invention, preferably the melt viscosity at 220° C., 1 sec⁻¹ is 100 to 1000 Pa·sec, more preferably 200 to 800 Pa·sec, and much more preferably 300 to 700 Pa·sec. Allowing the thermoplastic cellulose acetate propionate composition to have such a higher melt viscosity prevents the composition from being stretched under tension at the die outlet, thereby preventing the optical anisotropy (retardation) caused by stretch orientation from increasing.

Such viscosity adjustment can be performed by any means. For example, the adjustment can be performed by adjusting the polymerization degree of cellulose acylate or the amount of an additive such as a plasticizer.

(6) Pelletization

The above described cellulose acylate and additives are preferably mixed and pelletized prior to melt film formation.

In pelletization, it is preferable to dry the cellulose acylate mixture and additives in advance; however, if a vented extruder is used, the drying step can be omitted. When drying is performed, a drying method can be employed in which the cellulose acylate and additives are heated in a heating oven at 90° C. for 8 hours or more, though drying methods applicable in the present invention are not limited to this. Pelletization can be performed in such a manner that after melting the above described cellulose acylate and additives at temperatures of 150° C. or higher and 250° C. or lower using a twin-screw kneading extruder, the molten mixture is extruded in the form of noodles, and the noodle-shaped mixture is solidified in water, followed by cutting. Pelletization may also be performed by underwater cutting in which the above described cellulose acylate and additives are melted on an extruder and extruded through a ferrule directly in water, and cutting is performed in water while carrying out extrusion.

Any known extruder, such as single screw extruder, non-intermeshing counter-rotating twin-screw extruder, intermeshing counter-rotating twin-screw extruder, intermeshing corotating twin-screw extruder, can be used, as long as it enables melt kneading.

Preferably, the pellet size is such that the cross section is 1 mm² or larger and 300 mm² or smaller and the length is 1 mm or longer and 30 mm or shorter and more preferably the cross section is 2 mm² or larger and 100 mm² or smaller and the length is 1.5 mm or longer and 10 mm or shorter.

In pelletization, the above described additives may be fed through a raw material feeding opening or a vent located midway along the extruder.

The number of revolutions of the extruder is preferably 10 rpm or more and 1000 rpm or less, more preferably 20 rpm or more and 700 rpm or less, and much more preferably 30 rpm or more and 500 rpm or less. If the rotational speed is lower than the above described range, the residence time of the cellulose acylate and additives is increased, which undesirably causes heat deterioration of the mixture, and hence decrease in molecular weight and increase in color change to yellow. Further, if the rotational speed is higher than the above described range, molecule breakage by shear is more likely to occur, which gives rise to problems of decrease in molecular weight and increase in crosslinked gel.

The extrusion residence time in pelletization is preferably 10 seconds or longer and 30 minutes or shorter, more preferably 15 seconds or longer and 10 minutes or shorter, and much more preferably 30 seconds or longer and 3 minutes or shorter. As long as the resin mixture is sufficiently melt, shorter residence time is preferable, because shorter residence time enables the deterioration of resin or occurrence of yellowish color to be suppressed.

(7) Melt Film Formation

(i) Drying

The cellulose acylate mixture palletized by the above described method is preferably used, and the water content in the pellets is preferably decreased prior to the film formation.

In the present invention, to adjust the water content in the cellulose acylate to a desirable amount, it is preferable to dry the cellulose acylate. Drying is often carried out using an air dehumidification drier, but the method of drying is not limited to any specific one, as long as an intended water content is obtained (preferably drying is carried out efficiently by either any one of methods, such as heating, air blasting, pressure reduction and stirring, or two or more of them in combination, and more preferably a drying hopper having an insulating structure is used). The drying temperature is preferably 0 to 200° C., more preferably 40 to 180° C., and particularly preferably 60 to 150° C. Too low a drying temperature is not preferable, because if the drying temperature is too low, drying takes a longer time, and moreover, water content cannot be decreased to an intended value or lower. Too high a drying temperature is not preferable, either, because if the drying temperature is too high, the resin is adhered to cause blocking. The amount of drying air used is preferably 20 to 400 m³/hour, more preferably 50 to 300 m³/hour, and particularly preferably 100 to 250 m³/hour. Too small an amount of drying air is not preferable, because if the amount of drying air is too small, drying cannot be carried out efficiently. On the other hand, using too large an amount of drying air is not economical. This is because the drying effect cannot be drastically improved further even by using excess amount of drying air. The dew point of the air is preferably 0 to −60° C., more preferably −10 to −50° C., and particularly preferably −20 to −40° C. The drying time is required to be at least 15 minutes or longer, preferably 1 hour or longer and more preferably 2 hours or longer. However, the drying time exceeding 50 hours dose not drastically decrease the water content further and it might cause deterioration of the resin by heat. Thus, an unnecessarily long drying time is not preferable. In the cellulose acylate of the present invention, the water content is preferably 1.0% by mass or lower, more preferably 0.1% by mass or lower, and particularly preferably 0.01% by mass or lower.

(ii) Melt Extrusion

The above described cellulose acylate resin is fed in a cylinder through a feed opening of an extruder (which is different from the extruder for pelletization). The inside of the cylinder is constituted with a feed part (region A) of quantitatively conveying the cellulose acylate resin fed from the feed opening, a compression part (region B) of melt-kneading and compressing the cellulose acylate resin, and a conveying and measuring part (region C) of measuring the cellulose acylate resin that is melt-kneaded and compressed. In order to decrease a moisture content by the above described method, the resin is preferably dried, but for preventing oxidation of the molten resin by residual oxygen, drying is more preferably performed in an inert gas (such as nitrogen) flow inside the extruder or while exhausting in vacuum by using an extruder equipped with a bent. A screw compression ratio of the extruder is set at 2 to 5, and a L/D is set at 20 to 50. Herein, the screw compression ratio means a volume ratio of the feed part A to the conveying and measuring part C, that is, expressed by a volume of the feed part A par a unit length/a volume of the conveying and measuring part C par a unit length, and calculated using an outer diameter d1 of the screw axis of the feed part A, an outer diameter d2 of the screw axis of the conveying and measuring part C, a groove diameter a1 of the feed part A, and a groove diameter a2 of the conveying and measuring part C. In addition, a L/D is referred to as a ratio of a cylinder length to a cylinder inner diameter.

When a screw compression ratio is too small as lowering 2, the cellulose acylate resin is not sufficiently molten and kneaded, an insoluble portion may be generated or shear heat generation is too small so as to be insufficient in melting, which causes easily remaining fine crystals in the cellulose acylate film after production, and further, bubbles are likely to be mixed in. Thereby, strength of a cellulose acylate film is lowered, or when the cellulose acylate film is stretched, the remained crystals inhibit stretchability and orientation cannot be sufficiently increased. On the contrary, when the screw compression ratio is too large as exceeding 5, shear stress is overloaded and a resin easily deteriorates due to heat generation, and thus, the cellulose acylate film after production easily takes yellowish tone. In addition, as shear stress is overloaded, cutting of molecules is caused and a molecular weight is lowered, and thus, mechanical strength of the film is lowered. Therefore, in order that cellulose acylate film after production hardly takes a yellowish tone and film strength is large to be further hardly broken in stretching, the screw compression ratio is preferably in the range from 2 to 5, more preferably in the range from 2.5 to 4.5, and particularly preferably in the range from 3.0 to 4.0.

When the L/D is too small as lowering 20, insufficient melting and insufficient kneading are caused, and fine crystals are likely to remain in the cellulose acylate film after production in the same manner as in the case of a small compression ratio. Conversely, the L/D as high as more than 50 makes too long the residence time of the cellulose acylate resin in the extruder, which makes the resin more likely to deteriorate. Too long a residence time may cause molecule breakage, which results in decrease in molecular weight, and hence in mechanical strength of the film. Accordingly, to make the formed cellulose acylate film less likely to be yellow and less likely to break in stretching, the L/D is preferably in the range of 20 to 50, more preferably in the range of 25 to 45, and particularly preferably in the range of 23 to 40.

The extrusion temperature is preferably set in the above described temperature range. The cellulose acylate film thus obtained has the following characteristics: a haze of 2.0% or less; and a yellow index (YI value) of 10 or less.

The haze herein used is an index of whether the extrusion temperature is too low or not, in other words, an index of the amount of the crystals remaining in the formed cellulose acylate film. When the haze is more than 2.0%, the strength of the formed cellulose acylate film is likely to deteriorate and the breakage of the film is likely to occur. On the other hand, the yellow index (YI value) is an index of whether the extrusion temperature is too high or not. When the yellow index (YI value) is 10 or less, the formed cellulose acylate film is free from the problem of yellowing.

As extruder, generally single-screw extruder, which requires lower equipment costs, is often used.

The preferable diameter of the screw varies depending on the intended amount of the cellulose acylate resin extruded per unit time; however, it is preferably 10 mm or larger and 300 mm or smaller, more preferably 20 mm or larger and 250 mm or smaller, and much more preferably 30 mm or larger and 150 mm or smaller.

(iii) Filtration

To filter contaminants in the resin or avoid the damage to the gear pump caused by such contaminants, it is preferable to perform a so-called breaker-plate-type filtration which uses a filter medium provided at the extruder outlet. To filter contaminants with much higher precision, it is preferable to provide, after the gear pump, a filter in which a leaf-type disc filter is incorporated. Filtration can be performed with a single filtering section, or it can be multi-step filtration with a plurality of filtering sections. A filter medium with higher precision is preferably used; however, taking into consideration the pressure resistance of the filter medium or the increase in filtration pressure due to the clogging of the filter medium, the filtration precision is preferably 15 μm to 3 μm and more preferably 10 μm to 3 μm. A filter medium with higher precision is particularly preferably used when a leaf-type disc filter is used to perform final filtration of contaminants. And in order to ensure suitability of the filter medium used, the filtration precision may be adjusted by the number of filter media loaded, taking into account the pressure resistance and filter life. From the viewpoint of being used at high temperature and high pressure, the type of the filter medium used is preferably a steel material. Of the steel materials, stainless steel or steel is particularly preferably used. From the viewpoint of corrosion, desirably stainless steel is used. A filter medium constructed by weaving wires or a sintered filter medium constructed by sintering, for example, metal long fibers or metal powder can be used. However, from the viewpoint of filtration precision and filter life, a sintered filter medium is preferably used.

(iv) Gear Pump

To improve the thickness precision, it is important to decrease the fluctuation in the amount of the discharged resin and it is effective to provide a gear pump between the extruder and the die to feed a fixed amount of cellulose acylate resin through the gear pump. A gear pump is such that it includes a pair of gears—a drive gear and a driven gear—in mesh, and it drives the drive gear to rotate both the gears in mesh, thereby sucking the molten resin into the cavity through the suction opening formed on the housing and discharging a fixed amount of the resin through the discharge opening formed on the same housing. Even if there is a slight change in the resin pressure at the tip of the extruder, the gear pump absorbs the change, whereby the change in the resin pressure in the downstream portion of the film forming apparatus is kept very small, and the fluctuation in the film thickness is improved. Using a gear pump enables the fluctuation range of a resin pressure at a die part to be within ±1%.

To improve the fixed-amount feeding performance of the gear pump, a method can also be used in which the pressure before the gear pump is controlled to be constant by varying the number of revolution of the screw. Or the use of a high-precision gear pump is also effective in which three or more gears are used to eliminate the fluctuation in gear of a gear pump.

Other advantages of using a gear pump are such that it makes possible the film formation while reducing the pressure at the tip of the screw, which would be expected to reduce the energy consumption, prevent the increase in resin temperature, improve the transportation efficiency, decrease in the residence time of the resin in the extruder, and decrease the L/D of the extruder. Furthermore, when a filter is used to remove contaminants, if a gear pump is not used, the amount of the resin fed from the screw can sometimes vary with increase in filtration pressure. However, this variation in the amount of resin fed from the screw can be eliminated by using a gear pump. On the other hand, as demerits of the gear pump, a length of facility is enlarged depending on a method of selecting the facility, and thus, a retention time of a resin becomes long, and cutting of a molecular chain is caused by shear stress of the gear pump part, and therefore, attention is necessary.

Preferably, the residence time of the resin, from the time the resin enters the extruder through the feed opening to the time it goes out of the die, is 2 minutes or longer and 60 minutes or shorter, more preferably 3 minutes or longer and 40 minutes or shorter, and much more preferably 4 minutes or longer and 30 minutes or shorter.

If the flow of polymer circulating around the bearing of the gear pump is not smooth, the seal by the polymer at the driving portion and the bearing portion becomes poor, which may cause the problem of producing wide fluctuations in measurements and feeding and extruding pressures. Thus, the gear pump (particularly clearances thereof) should be designed to match to the melt viscosity of the cellulose acylate resin. In some cases, the portion of the gear pump where the cellulose acylate resides can be a cause of deterioration of the cellulose acylate resin. Thus, preferably the gear pump has a structure which allows the residence time of the cellulose acylate resin to be as short as possible. The polymer tubes or adaptors that connect the extruder with a gear pump or a gear pump with the die should be so designed that they allow the residence time of the cellulose acylate resin to be as short as possible. Furthermore, to stabilize the extrusion pressure of the cellulose acylate resin whose melt viscosity is highly temperature-dependent, preferably the fluctuation in temperature is kept as narrow as possible. Generally, a band heater, which requires lower equipment costs, is often used for heating polymer tubes; however, it is more preferable to use a cast-in aluminum heater which is less susceptible to temperature fluctuation. Further, for the purpose of stabilizing the discharge pressure in the extruder as described above, melting is preferably conducted by heating the extruder barrel with 3 or more and 20 or less divided heaters.

(v) Die

With the extruder constructed as above, the cellulose acylate resin is melted and the molten resin is continuously fed into a die, if necessary, through a filter or gear pump. Any type of commonly used die, such as T-die, fish-tail die or hanger coat die, may be used, as long as it allows the residence time of the molten resin to be short. Further, a static mixer can be introduced right before the T-die to increase the temperature uniformity. The clearance at the outlet of the T-die can be 1.0 to 5.0 times the film thickness, preferably 1.2 to 3 times the film thickness, and more preferably 1.3 to 2 times the film thickness. If the lip clearance is less than 1.0 time the film thickness, it is difficult to obtain a sheet whose surface state is good. Conversely, if the lip clearance is more than 5.0 times the film thickness, undesirably the thickness precision of the sheet is decreased. A die is very important equipment which determines the thickness precision of the film to be formed, and thus, one that can severely control the film thickness is preferably used. Although commonly used dies can control the film thickness at intervals of 40 to 50 mm, dies of a type which can control the film thickness at intervals of 35 mm or less and more preferably at intervals of 25 mm or less are preferable. In the cellulose acylate resin, since its melt viscosity is highly temperature-dependent and shear-rate-dependent, it is important to design a die that causes the least possible temperature uniformity and the least possible flow-rate uniformity across the width. The use of an automated thickness adjusting die, which measures the thickness of the film downstream, calculates the thickness deviation and feeds the calculated result back to the thickness adjustment, is also effective in decreasing fluctuations in thickness in the long-term continuous production of the cellulose acylate film.

In producing films, a single-layer film forming apparatus, which requires lower producing costs, is generally used. However, depending on the situation, it is also possible to use a multi-layer film forming apparatus to produce a film having 2 types or more of structure, in which an outer layer is formed as a functional layer. Generally, preferably a functional layer is laminated thin on the surface of the cellulose acylate film, but the layer-layer ratio is not limited to any specific one.

(vi) Cast

In the above described method, the molten resin extruded in a sheet form from the die is solidified by cooling on a cooling drum to obtain a film. In this process, it is preferable to increase adhesion of the cooling drum and the melt-extruded sheet by using methods such as an electrostatic impression method, an air knife method, an air chamber method, a vacuum nozzle method, and a touch roll method. These adhesion enhancing methods may be applied to either the whole surface or part of the surface of the sheet resulting from melt extrusion. A method, called as edge pinning, in which cooling drums are adhered to the edges of the film alone is often employed, but the adhesion enhancing method used in the present invention is not limited to this method.

Preferably, the molten resin sheet is cooled little by little using a plurality of cooling drums. Generally, such cooling is often performed using 3 cooling drums, but the number of cooling drums used is not limited to 3. The diameter of the cooling drums is preferably 100 mm or larger and 1000 mm or smaller and more preferably 150 mm or larger and 1000 mm or smaller. The spacing between the two adjacent drums of the plurality of drums is preferably 1 mm or larger and 50 mm or smaller and more preferably 1 mm or larger and 30 mm or smaller, in terms of face-face spacing.

The temperature of cooling drums is preferably 60° C. or higher and 160° C. or lower, more preferably 70° C. or higher and 150° C. or lower, and much more preferably 80° C. or higher and 140° C. or lower. The cooled and solidified sheet is then stripped off from the cooling drums, passed through take-off rollers (a pair of nip rollers), and wound up. The wind-up speed is preferably 10 m/min or higher and 100 m/min or lower, more preferably 15 m/min or higher and 80 m/min or lower, and much more preferably 20 m/min or higher and 70 m/min or lower.

The width of the film thus formed is preferably 0.7 m or more and 5 m or less, more preferably 1 m or more and 4 m or less, and much more preferably 1.3 m or more and 3 m or less. The thickness of the unstretched film thus obtained is preferably 30 μm or more and 400 μm or less, more preferably 40 μm or more and 300 μm or less, and much more preferably 50 μm or more and 200 μm or less.

When so-called touch roll method is used, the surface of the touch roll used may be made of rubber or resin such as Teflon (registered trademark), or metal. A roll, called as flexible roll, can also be used whose surface gets a little depressed by the pressure of a metal roll having a decreased thickness when the flexible roll and the metal roll touch with each other, and their pressure contact area is increased.

The temperature of the touch roll is preferably 60° C. or higher and 160° C. or lower, more preferably 70° C. or higher and 150° C. or lower, and much more preferably 80° C. or higher and 140° C. or lower.

(vii) Winding Up

Preferably, the sheet thus obtained is wound up with its edges trimmed away. The portions having been trimmed off may be reused as a raw material for the same kind of film or a different kind of film, after undergoing grinding or after undergoing granulation, or depolymerization or re-polymerization depending on the situation. Any type of trimming cutter, such as a rotary cutter, shearing blade or knife, may be used. The material of the cutter may be any such as carbon steel, stainless steel. Generally, a carbide-tipped blade or ceramic blade is preferably used, because use of such a blade makes the life of a cutter longer and suppresses the production of cuttings.

It is also preferable, from the viewpoint of preventing the occurrence of scratches on the sheet, to provide, prior to winding up, a laminating film at least on one side of the sheet. Preferably, the wind-up tension is 1 kg/m (in width) or higher and 50 kg/m (in width) or lower, more preferably 2 kg/m (in width) or higher and 40 kg/m (in width) or lower, and much more preferably 3 kg/m (in width) or higher and 20 kg/m (in width) or lower. If the wind-up tension is lower than 1 kg/m (in width), it is difficult to wind up the film uniformly. Conversely, if the wind-up tension is higher than 50 kg/m (in width), undesirably the film is too tightly wound, whereby the appearance of wound film deteriorates, and the knot portion of the film is stretched due to the creep phenomenon, causing surging in the film, or residual double refraction occurs due to the extension of the film. Preferably, the winding up is performed while detecting the wind-up tension with a tension control provided midway along the line and controlling the same to be constant. When there is a difference in the film temperature depending on the spot on the film forming line, a slight difference in the film length can sometimes be created due to thermal expansion, and thus, it is necessary to adjust the draw ratio of the nip rolls so that tension higher than a prescribed one should not be applied to the film.

Preferably, the winding up of the film is performed while tapering the amount of the film to be wound according to the winding diameter so that a proper wind-up tension is kept, though it can be performed while keeping the wind-up tension constant by the control with the tension control. Generally, the wind-up tension is decreased little by little with increase in the winding diameter; however, it can sometimes be preferable to increase the wind-up tension with increase in the winding diameter.

(viii) Physical Properties of Unstretched Cellulose Acylate Film

In the unstretched cellulose acylate film thus obtained preferably Re=0 to 20 nm and Rth=0 to 80 nm, more preferably Re=0 to 15 nm and Rth=0 to 70 nm, and furthermore preferably Re=0 to 10 nm and Rth=0 to 60 nm. Re and Rth represent in-plane retardation and across-the-thickness retardation, respectively. Re is measured using KOBRA 21ADH (manufactured by Oji Scientific Instruments) while allowing light to enter the unstretched cellulose acylate film normal to its surface. Rth is calculated based on three retardation measurements: the Re measured as above, and the Rth measured while allowing light to enter the film from the direction inclined at angles of +40°, −40°, respectively, to the direction normal to the film using the slow axis in plane as a tilt axis (rotational axis). Preferably, the angle θ between the direction of the film formation (across the length) and the slow axis of the Re of the film is made as close to 0°, +90° or −90° as possible.

The total light transmittance is preferably 90% to 100%, more preferably 91 to 99% or higher, and much more preferably 92 to 98%. Preferably, the haze is 0 to 1%, more preferably 0 to 0.8% and much more preferably 0 to 0.6%.

Preferably, the thickness non-uniformity both in the longitudinal direction and the transverse direction is 0% or more and 4% or less, more preferably 0% or more and 3% or less, and much more preferably 0% or more and 2% or less. Preferably, the modulus in tension is 1.5 kN/mm² or more and 3.5 kN/mm² or less, more preferably 1.7 kN/mm² or more and 2.8 kN/mm² or less, and much more preferably 1.8 kN/mm² or more and 2.6 kN/mm² or less.

Preferably, the breaking extension is 3% or more and 100% or less, more preferably 5% or more and 80% or less, and much more preferably 8% or more and 50% or less.

Preferably, the Tg (this indicates the Tg of the film, that is, the Tg of the mixture of cellulose acylate and additives) is 95° C. or higher and 145° C. or lower, more preferably 100° C. or higher and 140° C. or lower, and much more preferably 105° C. or higher and 135° C. or lower.

Preferably, the dimensional change by heat at 80° C. per day is 0% or higher ±1% or less both in the longitudinal direction and the transverse direction, more preferably 0% or higher ±0.5% or less, and much more preferably 0% or higher ±0.3% or less.

Preferably, the water permeability at 40° C., 90% rh is 300 g/m²·day or higher and 1000 g/m²·day or lower, more preferably 400 g/m²·day or higher and 900 g/m²·day or lower, and much more preferably 500 g/m²·day or higher and 800 g/m²·day or lower.

Preferably, the average water content at 25° C., 80% rh is 1 wt % or higher and 4 wt % or lower, more preferably 1.2 wt % or higher and 3 wt % or lower, and much more preferably 1.5 wt % or higher and 2.5 wt % or lower.

(8) Stretching

The film formed by the above described process may be stretched. The Re and Rth of the film can be controlled by stretching.

Preferably, stretching is carried out at temperatures of Tg or higher and Tg+50° C. or lower, more preferably at temperatures of Tg+3° C. or higher and Tg+30° C. or lower, and much more preferably at temperatures of Tg+5° C. or higher and Tg+20° C. or lower. Preferably, the stretch magnification is 1% or higher and 300% or lower at least in one direction, more preferably 2% or higher and 250% or lower, and much more preferably 3% or higher and 200% or lower. The stretching can be performed equally in both longitudinal and transverse directions; however, preferably it is performed unequally so that the stretch magnification in one direction is larger than that of the other direction. Either the stretch magnification in the longitudinal direction (MD) or that in the transverse direction (TD) may be made larger. Preferably, the smaller value of the stretch magnification is 1% or more and 30% or less, more preferably 2% or more and 25% or less, and much more preferably 3% or more and 20% or less. Preferably, the larger one is 30% or more and 300% or less, more preferably 35% or more and 200% or less, and much more preferably 40% or more and 150% or less. The stretching operation can be carried out in one step or in a plurality of steps. The term “stretch magnification” herein used means the value obtained using the following equation.

Stretch magnification(%)=100×{(length after stretching)−(length before stretching)}/(length before stretching)

The stretching may be performed in the longitudinal direction by using 2 or more pairs of nip rolls and controlling the peripheral velocity of the pairs of nip rolls so that the velocity of the pair on the outlet side is faster than that of the other one(s) (longitudinal stretching) or in the transverse direction (in the direction perpendicular to the longitudinal direction) while allowing both ends of the film to be gripped by a chuck (transverse stretching). Further, the stretching may be performed using the simultaneous biaxial stretching method described in Japanese Patent Application Laid-Open Nos. 2000-37772, 2001-113591 and 2002-103445.

In the longitudinal stretching, the Re-to-Rth ratio can be freely controlled by controlling the value obtained by dividing the distance between two pairs of nip rolls by the width of the film (length-to-width ratio). In other words, the ratio Rth/Re can be increased by decreasing the length-to-width ratio. Further, Re and Rth can also be controlled by combining the longitudinal stretching and the transverse stretching. In other words, Re can be decreased by decreasing the difference between the percent of longitudinal stretch and the percent of the transverse stretch, while Re can be increased by increasing the difference between the same.

Preferably, the Re and Rth of the cellulose acylate film thus stretched satisfy the following formulas,

Rth≧Re

200≧Re≧0

500≧Rth≧30

more preferably,

Rth≧Re×1.1

150≧Re≧10

400≧Rth≧50

and furthermore preferably,

Rth≧Re×1.2

100≧Re≧20

350≧Rth≧80.

Preferably, the angle θ between the film funning direction (longitudinal direction) and the slow axis of Re of the film is as close to 0°, +90° or −90° as possible. Specifically, in the longitudinal stretching, preferably the angle θ is as close to 0° as possible, and it is preferably 0±3°, more preferably 0±2° and much more preferably 0±1°. In the transverse stretching, the angle θ is preferably 90±3° or −90±3°, more preferably 90±2° or −90±2°, and much more preferably 90±1° or −90±1°.

The thickness of the cellulose acylate film after stretching is preferably 30 μm or more and 300 μm or less, more preferably 30 μm or more and 170 μm or less, and furthermore preferably 40 μm or more and 140 μm or less. In each of the lengthwise direction and the widthwise direction, the thickness unevenness is preferably 0% or more and 3% or less, more preferably 0% or more and 2% or less, and furthermore preferably 0% or more and 1% or less.

The physical properties of the stretched cellulose acylate film are preferably in the following range.

Preferably, the modulus in tension is 1.5 kN/mm² or more and less than 3.0 kN/mm², more preferably 1.7 kN/mm² or more and 2.8 kN/mm² or less, and much more preferably 1.8 kN/mm² or more and 2.6 kN/mm² or less.

Preferably, the breaking extension is 3% or more and 100% or less, more preferably 5% or more and 80% or less, and much more preferably 8% or more and 50% or less.

Preferably, the Tg (this indicates the Tg of the film, that is, the Tg of the mixture of cellulose acylate and additives) is 95° C. or higher and 145° C. or lower, more preferably 100° C. or higher and 140° C. or lower, and much more preferably 105° C. or higher and 135° C. or lower.

Preferably, the dimensional change by heat at 80° C. per day is 0% or higher ±1% or less both in the longitudinal direction and the transverse direction, more preferably 0% or higher ±0.5% or less, and much more preferably 0% or higher ±0.3% or less.

Preferably, the water permeability at 40° C., 90% is 300 g/m²·day or higher and 1000 g/m²·day or lower, more preferably 400 g/m²·day or higher and 900 g/m²·day or lower, and much more preferably 500 g/m²·day or higher and 800 g/m²·day or lower.

Preferably, the average water content at 25° C., 80% rh is 1 wt % or higher and 4 wt % or lower, more preferably 1.2 wt % or higher and 3 wt % or lower, and much more preferably 1.5 wt % or higher and 2.5 wt % or lower.

The thickness is preferably 30 μm or more and 200 μm or less, more preferably 40 μm or more and 180 μm or less, and much more preferably 50 μm or more and 150 μm or less.

The haze is 0% or more and 3% or less, more preferably 0% or more and 2% or less, and much more preferably 0% or more and 1% or less.

The total light transmittance is preferably 90% or higher to 100% or lower, more preferably 91% or higher to 99% or lower, and much more preferably 92% or higher to 98% or lower.

(9) Surface Treatment

The adhesion of both unstretched and stretched cellulose acylate films to each functional layer (e.g. undercoat layer and back layer) can be improved by subjecting them to surface treatment. Examples of types of surface treatment applicable include: treatment using glow discharge, ultraviolet irradiation, corona discharge, flame, or acid or alkali. The glow discharge treatment mentioned herein may be treatment using low-temperature plasma generated in a low-pressure gas at 10⁻³ to 20 Torr. Or plasma treatment at atmospheric pressure is also preferable. Plasma excitation gases are gases that undergo plasma excitation under the above described conditions, and examples of such gases include: argon, helium, neon, krypton, xenon, nitrogen, carbon dioxide, ions such as tetrafluoromethane, and the mixtures thereof. These are described in detail in Journal of Technical Disclosure (Laid-Open No. 2001-1745, issued on Mar. 15, 2001, by Japan Institute of Invention and Innovation), 30-32. In the plasma treatment at atmospheric pressure, which has attracted considerable attention in recent years, for example, irradiation energy of 20 to 500 Kgy is used at 10 to 1000 Kev, and preferably irradiation energy of 20 to 300 Kgy is used at 30 to 500 Kev. Of the above described types of treatment, most preferable is alkali saponification, which is extremely effective as surface treatment for cellulose acylate films. Specific examples include: those described in Japanese Patent Application Laid-Open Nos. 2003-3266, 2003-229299, 2004-322928 and 2005-76088.

Alkali saponification may be carried out by immersing the film in a saponifying solution or by coating the film with a saponifying solution. The saponification by immersion can be achieved by allowing the film to pass through a bath, in which an aqueous solution of NaOH or KOH with pH of 10 to 14 has been heated to 20° C. to 80° C., over 0.1 to 10 minutes, neutralizing the same, water-washing the neutralized film, followed by drying.

The saponification by coating can be carried out using a coating method such as dip coating, curtain coating, extrusion coating, bar coating or E-coating. A solvent for alkali-saponification solution is preferably selected from solvents that allow the saponifying solution to have excellent wetting characteristics when the solution is applied to a transparent substrate; and allow the surface of a transparent substrate to be kept in a good state without causing irregularities on the surface. Specifically, alcohol solvents are preferable, and isopropyl alcohol is particularly preferable. An aqueous solution of surfactant can also be used as a solvent. As an alkali for the alkali-saponification coating solution, an alkali soluble in the above described solvent is preferable, and KOH or NaOH is more preferable. The pH of the alkali-saponification coating solution is preferably 10 or more and more preferably 12 or more. Preferably, the alkali saponification reaction is carried at room temperature for 1 second or longer and 5 minutes or shorter, more preferably for 5 seconds or longer and 5 minutes or shorter, and particularly preferably for 20 seconds or longer and 3 minutes or shorter. It is preferable to wash the saponifying solution-coated surface with water or an acid and wash the surface with water again after the alkali saponification reaction. The coating-type saponification and the removal of orientation layer described later can be performed continuously, whereby the number of the producing steps can be decreased. The details of these saponifying processes are described in, for example, Japanese Patent Application Laid-Open No. 2002-82226 and WO 02/46809.

To improve the adhesion of the unstretched or stretched cellulose acylate film to each functional layer, it is preferable to provide an undercoat layer on the cellulose acylate film. The undercoat layer may be provided after carrying out the above described surface treatment or without the surface treatment. The details of the undercoat layers are described in Journal of Technical Disclosure (Laid-Open No. 2001-1745, issued on Mar. 15, 2001, by Japan Institute of Invention and Innovation), 32.

These surface-treatment step and under-coat step can be incorporated into the final part of the film forming step, or they can be performed independently, or they can be performed in the functional-layer providing process.

(10) Providing Functional Layer

Preferably, the stretched and unstretched cellulose acylate films of the present invention are combined with any one of the functional layers described in detail in Journal of Technical Disclosure (Laid-Open No. 2001-1745, issued on Mar. 15, 2001, by Japan Institute of Invention and Innovation), 32-45. Particularly preferable is providing a polarizing layer (polarizing plate), optical compensation layer (optical compensation film), antireflection layer (antireflection film) or hard coat layer.

(i) Providing Polarizing Layer (Preparation of Polarizing Plate)

[Materials Used for Polarizing Layer]

At the present time, generally, commercially available polarizing layers are prepared by immersing stretched polymer in a solution of iodine or a dichroic dye in a bath so that the iodine or dichroic dye penetrates into the binder. Coating-type of polarizing films, represented by those manufactured by Optiva Inc., are also available as a polarizing film. Iodine or a dichroic dye in the polarizing film develops polarizing properties when its molecules are oriented in a binder. Examples of dichroic dyes applicable include: azo dye, stilbene dye, pyrazolone dye, triphenylmethane dye, quinoline dye, oxazine dye, thiazine dye and anthraquinone dye. The dichroic dye used is preferably water-soluble. The dichroic dye used preferably has a hydrophilic substitute (e.g. sulfo, amino, or hydroxyl). Example of such dichroic dyes includes: compounds described in Journal of Technical Disclosure, Laid-Open No. 2001-1745, 58, (issued on Mar. 15, 2001, by Japan Institute of Invention and Innovation).

Any polymer which is crosslinkable in itself or which is crosslinkable in the presence of a crosslinking agent can be used as a binder for polarizing films. And more than one combination thereof can also be used as a binder. Examples of binders applicable include: compounds described in Japanese Patent Application Laid-Open No. 8-338913, column [0022], such as methacrylate copolymers, styrene copolymers, polyolefin, polyvinyl alcohol and denatured polyvinyl alcohol, poly(N-methylolacrylamide), polyester, polyimide, vinyl acetate copolymer, carboxymethylcellulose, and polycarbonate. Silane coupling agents can also be used as a polymer. Preferable are water-soluble polymers (e.g. poly(N-methylolacrylamide), carboxymethylcellulose, gelatin, polyvinyl alcohol and denatured polyvinyl alcohol), more preferable are gelatin, polyvinyl alcohol and denatured polyvinyl alcohol, and most preferable are polyvinyl alcohol and denatured polyvinyl alcohol. Use of two kinds of polyvinyl alcohol or denatured polyvinyl alcohol having different polymerization degrees in combination is particularly preferable. The saponification degree of polyvinyl alcohol is preferably 70 to 100% and more preferably 80 to 100%. The polymerization degree of polyvinyl alcohol is preferably 100 to 5000. Details of denatured polyvinyl alcohol are described in Japanese Patent Application Laid-Open Nos. 8-338913, 9-152509 and 9-316127. For polyvinyl alcohol and denatured polyvinyl alcohol, two or more kinds may be used in combination.

Preferably, the minimum of the binder thickness is 10 μm. For the maximum of the binder thickness, from the viewpoint of light leakage of liquid crystal displays, preferably the binder has the smallest possible thickness. The thickness of the binder is preferably equal to or smaller than that of currently commercially available polarizing plate (about 30 μm), more preferably 25 μm or smaller, and much more preferably 20 μm or smaller.

The binder for polarizing films may be crosslinked. Polymer or monomer that has a crosslinkable functional group may be mixed into the binder. Or a crosslinkable functional group may be provided to the binder polymer itself. Crosslinking reaction is allowed to progress by means of light, heat or pH changes, and a binder having a crosslinked structure can be formed by crosslinking reaction. Examples of crosslinking agents applicable are described in U.S. Pat. (Reissued) No. 23297. Boron compounds (e.g. boric acid and borax) may also be used as a crosslinking agent. The amount of the crosslinking agent added to the binder is preferably 0.1 to 20% by mass of the binder. This allows polarizing devices to have good orientation characteristics and polarizing films to have good damp heat resistance.

The amount of the unreacted crosslinking agent after completion of the crosslinking reaction is preferably 1.0% by mass or less and more preferably 0.5% by mass or less. Restraining the unreacted crosslinking agent to such an amount improves the weatherability of the binder.

[Stretching of Polarizing Film]

Preferably, a polarizing film is dyed with iodine or a dichroic dye after undergoing stretching (stretching process) or rubbing (rubbing process).

In the stretching process, preferably the stretching magnification is 2.5 to 30.0 and more preferably 3.0 to 10.0. Stretching can be dry stretching, which is performed in the air. Stretching can also be wet stretching, which is performed while immersing a film in water. The stretching magnification in the dry stretching is preferably 2.5 to 5.0, while the stretching magnification in the wet stretching is preferably 3.0 to 10.0. Stretching may be performed parallel to the MD direction (parallel stretching) or in an oblique (oblique stretching). These stretching operations may be performed at one time or in several installments. Stretching can be performed more uniformly even in high-ratio stretching if it is performed in several installments. Oblique stretching in which stretching is performed in an oblique while tilting a film at an angle of 10 degrees to 80 degrees is more preferable.

(I) Parallel Stretching Process

Prior to stretching, a PVA film is swelled. The degree of swelling is 1.2 to 2.0 (ratio of mass before swelling to mass after swelling). After this swelling operation, the PVA film is stretched in a water-based solvent bath or in a dye bath in which a dichroic substance is dissolved at a bath temperature of 15 to 50° C., preferably 17 to 40° C. while continuously conveying the film via a guide roll etc. Stretching can be accomplished in such a manner as to grip the PVA film with 2 pairs of nip rolls and control the conveying speed of nip rolls so that the conveying speed of the latter pair of nip rolls is higher than that of the former pair of nip rolls. The stretching magnification is based on the length of PVA film after stretching/the length of the same in the initial state ratio (hereinafter the same), and from the viewpoint of the above described advantages, the stretching magnification is preferably 1.2 to 3.5 and more preferably 1.5 to 3.0. After this stretching operation, the film is dried at 50° C. to 90° C. to obtain a polarizing film.

(II) Oblique Stretching Process

Oblique stretching can be performed by the method described in Japanese Patent Application Laid-Open No. 2002-86554 in which a tenter that projects on a tilt is used. This stretching is performed in the air; therefore, it is necessary to allow a film to contain water so that the film is easy to stretch. Preferably, the water content in the film is 5% or higher and 100% or lower, the stretching temperature is 40° C. or higher and 90° C. or lower, and the humidity during the stretching operation is preferably 50% rh or higher and 100% rh or lower.

The absorbing axis of the polarizing film thus obtained is preferably 10 degrees to 80 degrees, more preferably 30 degrees to 60 degrees, and much more preferably substantially 45 degrees (40 degrees to 50 degrees).

[Lamination]

The above described stretched and unstretched cellulose acylate films having undergone saponification and the polarizing layer prepared by stretching are laminated to prepare a polarizing plate. They may be laminated in any direction, but preferably they are laminated so that the angle between the direction of the film casting axis and the direction of the polarizing plate stretching axis is 0 degree, 45 degrees or 90 degrees.

Any adhesive can be used for the lamination. Examples of adhesives applicable include: PVA resins (including denatured PVA such as acetoacetyl, sulfonic, carboxyl or oxyalkylen group) and aqueous solutions of boron compounds. Of these adhesives, PVA resins are preferable. The thickness of the adhesive layer is preferably 0.01 to 10 μM and particularly preferably 0.05 to 5 μm, on a dried layer basis.

Examples of configurations of laminated layers are as follows:

a. A/P/A

b. A/P/B

c. A/P/T

d. B/P/B

e. B/P/T

where A represents an unstretched film of the present invention, B a stretched film of the present invention, T a cellulose triacetate film (Fujitack), and P a polarizing layer. In the configurations a, b, A and B may be cellulose acetate having the same composition, or they may be different. In the configuration d, two Bs may be cellulose acetate having the same composition, or they may be different, and their stretching rates may be the same or different. When sheets of polarizing plate are used as an integral part of a liquid crystal display, they may be integrated into the display with either side of them facing the liquid crystal surface; however, in the configurations b, e, preferably B is allowed to face the liquid crystal surface.

In the liquid crystal displays into which sheets of polarizing plate are integrated, usually a substrate including liquid crystal is arranged between two sheets of polarizing plate; however, the sheets of polarizing plate of a to e of the present invention and commonly used polarizing plate (T/P/T) can be freely combined. On the outermost surface of a liquid crystal display, however, preferably a transparent hard coat layer, an anti-glare layer, antireflection layer and the like is provided, and as such a layer, any one of layers described later can be used.

Preferably, the sheets of polarizing plate thus obtained have a high light transmittance and a high degree of polarization. The light transmittance of the polarizing plate is preferably in the range of 30 to 50% at a wavelength of 550 nm, more preferably in the range of 35 to 50%, and most preferably in the range of 40 to 50%. The degree of polarization is preferably in the range of 90 to 100% at a wavelength of 550 nm, more preferably in the range of 95 to 100%, and most preferably in the range of 99 to 100%.

The sheets of polarizing plate thus obtained can be laminated with a λ/4 plate to create circularly polarized light. In this case, they are laminated so that the angle between the slow axis of the λ/4 plate and the absorbing axis of the polarizing plate is 45 degrees. Any λ/4 plate can be used to create circularly polarized light; however, preferably one having such wavelength-dependency that retardation is decreased with decrease in wavelength is used. More preferably, a polarizing film having an absorbing axis which tilts 20 degrees to 70 degrees in the longitudinal direction and a λ/4 plate that includes an optically anisotropic layer made up of a liquid crystalline compound are used.

These sheets of polarizing plate may include a protective film laminated on one side and a separate film on the other side. Both protective film and separate film are used for protecting sheets of polarizing plate at the time of their shipping, inspection and the like.

(ii) Providing Optical Compensation Layer (Preparation of Optical Compensation Film)

An optically anisotropic layer is used for compensating the liquid crystalline compound in a liquid crystal cell in black display by a liquid crystal display. It is prepared by forming an orientation film on each of the stretched and unstretched cellulose acylate films and providing an optically anisotropic layer on the orientation film.

[Orientation Film]

An orientation film is provided on the above described stretched and unstretched cellulose acylate films which have undergone surface treatment. This film has the function of specifying the orientation direction of liquid crystalline molecules. However, this film is not necessarily indispensable constituent of the present invention. This is because a liquid crystalline compound plays the role of the orientation film, as long as the oriented state of the liquid crystalline compound is fixed after it undergoes orientation treatment. In other words, the sheets of polarizing plate of the present invention can also be prepared by transferring only the optically anisotropic layer on the orientation film, where the orientation state is fixed, on the polarizing plate.

An orientation film can be provided using a technique such as rubbing of an organic compound (preferably polymer), oblique deposition of an inorganic compound, formation of a micro-groove-including layer, or built-up of an organic compound (e.g. ω-tricosanic acid, dioctadecyl methyl ammonium chloride, methyl stearate) by Langmur-Blodgett technique (LB membrane). Orientation films in which orientation function is produced by the application of electric field, electromagnetic field or light irradiation are also known.

Preferably, the orientation film is formed by rubbing of polymer. As a general rule, the polymer used for the orientation film has a molecular structure having the function of orienting liquid crystalline molecules.

In the present invention, preferably the orientation film has not only the function of orienting liquid crystalline molecules, but also the function of combining a side chain having a crosslinkable functional group (e.g. double bond) with the main chain or the function of introducing a crosslinkable functional group having the function of orienting liquid crystalline molecules into a side chain.

Either polymer which is crosslinkable in itself or polymer which is crosslinkable in the presence of a crosslinking agent can be used for the orientation film. And a plurality of the combinations thereof can also be used. Examples of such polymer include: those described in Japanese Patent Application Laid-Open No. 8-338913, column [0022], such as methacrylate copolymers, styrene copolymers, polyolefin, polyvinyl alcohol and denatured polyvinyl alcohol, poly(N-methylolacrylamide), polyester, polyimide, vinyl acetate copolymer, carboxymethylcellulose, and polycarbonate. Silane coupling agents can also be used as a polymer. Preferable are water-soluble polymers (e.g. poly(N-methylolacrylamide), carboxymethylcellulose, gelatin, polyvinyl alcohol and denatured polyvinyl alcohol), more preferable are gelatin, polyvinyl alcohol and denatured polyvinyl alcohol, and most preferable are polyvinyl alcohol and denatured polyvinyl alcohol. Use of two kinds of polyvinyl alcohol or denatured polyvinyl alcohol having different polymerization degrees in combination is particularly preferable. The saponification degree of polyvinyl alcohol is preferably 70 to 100% and more preferably 80 to 100%. The polymerization degree of polyvinyl alcohol is preferably 100 to 5000.

Side chains having the function of orienting liquid crystal molecules generally have a hydrophobic group as a functional group. The kind of the functional group is determined depending on the kind of liquid crystalline molecules and the oriented state required. For example, a denatured group of denatured polyvinyl alcohol can be introduced by copolymerization denaturation, chain transfer denaturation or block polymerization denaturation. Examples of denatured groups include: hydrophilic groups (e.g. carboxylic, sulfonic, phosphonic, amino, ammonium, amide and thiol groups); hydrocarbon groups with 10 to 100 carbon atoms; fluorine-substituted hydrocarbon groups; thioether groups; polymerizable groups (e.g. unsaturated polymerizable groups, epoxy group, azirinyl group); and alkoxysilyl groups (e.g. trialkoxy, dialkoxy, monoalkoxy). Specific examples of these denatured polyvinyl alcohol compounds include: those described in Japanese Patent Application Laid-Open No. 2000-155216, columns [0022] to [0145], Japanese Patent Application Laid-Open No. 2002-62426, columns [0018] to [0022].

Combining a side chain having a crosslinkable functional group with the main chain of the polymer of an orientation film or introducing a crosslinkable functional group into a side chain having the function of orienting liquid crystal molecules makes it possible to copolymerize the polymer of the orientation film and the polyfunctional monomer contained in the optically anisotropic layer. As a result, not only the molecules of the polyfunctional monomer, but also the molecules of the polymer of the orientation film and those of the polyfunctional monomer and the polymer of the orientation film are covalently firmly bonded together. Thus, introduction of a crosslinkable functional group into the polymer of an orientation film enables remarkable improvement in the strength of optical compensation films.

The crosslinkable functional group of the polymer of the orientation film preferably has a polymerizable group, like the polyfunctional monomer. Specific examples of such crosslinkable functional groups include: those described in Japanese Patent Application Laid-Open No. 2000-155216, columns [0080] to [0100]. The polymer of the orientation film can be crosslinked using a crosslinking agent, besides the above described crosslinkable functional groups.

Examples of crosslinking agents applicable include: aldehyde; N-methylol compounds; dioxane derivatives; compounds that function by the activation of their carboxyl group; activated vinyl compounds; activated halogen compounds; isoxazol; and dialdehyde starch. Two or more kinds of crosslinking agents may be used in combination. Specific examples of such crosslinking agents include: compounds described in Japanese Patent Application Laid-Open No. 2002-62426, columns [0023] to [0024]. Aldehyde, which is highly reactive, particularly glutaraldehyde is preferably used as a crosslinking agent.

The amount of the crosslinking agent added is preferably 0.1 to 20% by mass of the polymer and more preferably 0.5 to 15% by mass. The amount of the unreacted crosslinking agent remaining in the orientation film is preferably 1.0% by mass or less and more preferably 0.5% by mass or less. Controlling the amount of the crosslinking agent and unreacted crosslinking agent in the above described manner makes it possible to obtain a sufficiently durable orientation film, in which reticulation does not occur even after it is used in a liquid crystal display for a long time or it is left in an atmosphere of high temperature and high humidity for a long time.

Basically, an orientation film can be formed by: coating the above described polymer, as a material for forming an orientation film, on a transparent substrate containing a crosslinking agent; heat drying (crosslinking) the polymer; and rubbing the same. The crosslinking reaction may be carried out at any time after the polymer is applied to the transparent substrate, as described above. When a water-soluble polymer, such as polyvinyl alcohol, is used as the material for forming an orientation film, the coating solution is preferably a mixed solvent of an organic solvent having an anti-foaming function (e.g. methanol) and water. The mixing ratio is preferably such that water:methanol=0:100 to 99:1 and more preferably 0:100 to 91:9. The use of such a mixed solvent suppresses the generation of foam, thereby significantly decreasing defects not only in the orientation film, but also on the surface of the optically anisotropic layer.

As a coating method for coating an orientation film, spin coating, dip coating, curtain coating, extrusion coating, rod coating or roll coating is preferably used. Particularly preferably used is rod coating. The thickness of the film after drying is preferably 0.1 to 10 μm. The heat drying can be carried out at 20° C. to 110° C. To achieve sufficient crosslinking, preferably the heat drying is carried out at 60° C. to 100° C. and particularly preferably at 80° C. to 100° C. The drying time can be 1 minute to 36 hours, but preferably it is 1 minute to 30 minutes. Preferably, the pH of the coating solution is set to a value optimal to the crosslinking agent used. When glutaraldehyde is used, the pH is 4.5 to 5.5 and particularly preferably 5.

The orientation film is provided on the stretched and unstretched cellulose acylate films or on the above described undercoat layer. The orientation film can be obtained by crosslinking the polymer layer and providing rubbing treatment on the surface of the polymer layer, as described above.

The above described rubbing treatment can be carried out using a treatment method widely used in the treatment of liquid crystal orientation in LCD. Specifically, orientation can be obtained by rubbing the surface of the orientation film in a fixed direction with paper, gauze, felt, rubber or nylon, polyester fiber and the like. Generally the treatment is carried out by repeating rubbing a several times using a cloth in which fibers of uniform length and diameter have been uniformly transplanted.

In the rubbing treatment industrially carried out, rubbing is performed by bringing a rotating rubbing roll into contact with a running film including a polarizing layer. The circularity, cylindricity and deviation (eccentricity) of the rubbing roll are preferably 30 μm or less respectively. The wrap angle of the film wrapping around the rubbing roll is preferably 0.1 to 90°. However, as described in Japanese Patent Application Laid-Open No. 8-160430, if the film is wrapped around the rubbing roll at 360° or more, stable rubbing treatment is ensured. The conveying speed of the film is preferably 1 to 100 m/min. Preferably, the rubbing angle is properly selected from the range of 0 to 60°. When the orientation film is used in liquid crystal displays, the rubbing angle is preferably 40 to 50° and particularly preferably 45°.

The thickness of the orientation film thus obtained is preferably in the range of 0.1 to 10 μm.

Then, liquid crystalline molecules of the optically anisotropic layer are oriented on the orientation film. After that, if necessary, the polymer of the orientation film and the polyfunctional monomer contained in the optically anisotropic layer are reacted, or the polymer of the orientation film is crosslinked using a crosslinking agent.

The liquid crystalline molecules used for the optically anisotropic layer include: rod-shaped liquid crystalline molecules and discotic liquid crystalline molecules. The rod-shaped liquid crystalline molecules and discotic liquid crystalline molecules may be either high-molecular-weight liquid crystalline molecules or low-molecular-weight liquid crystalline molecules, and they include low-molecule liquid crystalline molecules which have undergone crosslinking and do not show liquid crystallinity any more.

[Rod-Shaped Liquid Crystalline Molecules]

Examples of rod-shaped liquid crystalline molecules preferably used include: azomethines, azoxys, cyanobiphenyls, cyanophenyl esters, benzoate esters, cyclohexane carboxylic acid phenyl esters, cyanophenyl cyclohexanes, cyano-substituted phenyl pyrimidines, alkoxy-substituted phenyl pyrimidines, phenyl dioxanes, tolans, and alkenyl cyclohexyl benzonitriles.

Rod-shaped liquid crystalline molecules also include metal complexes. Liquid crystal polymer that includes rod-shaped liquid crystalline molecules in its repeating unit can also be used as rod-shaped liquid crystalline molecules. In other words, rod-shaped liquid crystalline molecules may be bonded to (liquid crystal) polymer.

Rod-shaped liquid crystalline molecules are described in Kikan Kagaku Sosetsu (Survey of Chemistry, Quarterly), Vol. 22, Chemistry of Liquid Crystal (1994), edited by The Chemical Society of Japan, Chapters 4, 7 and 11 and in Handbook of Liquid Crystal Devices, edited by 142th Committee of Japan Society for the Promotion of Science, Chapter 3.

The index of birefringence of the rod-shaped liquid crystalline molecules is preferably in the range of 0.001 to 0.7.

To allow the oriented state to be fixed, preferably the rod-shaped liquid crystalline molecules have a polymerizable group. As such a polymerizable group, a radically polymerizable unsaturated group or cationically polymerizable group is preferable. Specific examples of such polymerizable groups include: polymerizable groups and polymerizable liquid crystal compounds described in Japanese Patent Application Laid-Open No. 2002-62427, columns [0064] to [0086].

[Discotic Liquid Crystalline Molecules]

Discotic liquid crystalline molecules include: benzene derivatives described in the research report by C. Destrade et al., Mol. Cryst. Vol. 71, 111 (1981); truxene derivatives described in the research report by C. Destrade et al., Mol. Cryst. Vol. 122, 141 (1985) and Physics lett, A, Vol. 78, 82 (1990); cyclohexane derivatives described in the research report by B. Kohne et al., Angew. Chem. Vol. 96, 70 (1984); and azacrown or phenylacetylene macrocycles described in the research report by J. M. Lehn et al., J. Chem. Commun., 1794 (1985) and in the research report by J. Zhang et al., L. Am. Chem. Soc. Vol. 116, 2655 (1994).

Discotic liquid crystalline molecules also include liquid crystalline compounds having a structure in which straight-chain alkyl group, alkoxy group and substituted benzoyloxy group are substituted radially as the side chains of the mother nucleus at the center of the molecules. Preferably, the compounds are such that their molecules or groups of molecules have rotational symmetry and they can provide an optically anisotropic layer with a fixed orientation. In the ultimate state of the optically anisotropic layer formed of discotic liquid crystalline molecules, the compounds contained in the optically anisotropic layer are not necessarily discotic liquid crystalline molecules. The ultimate state of the optically anisotropic layer also contain compounds such that they are originally of low-molecular-weight discotic liquid crystalline molecules having a group reactive with heat or light, but undergo polymerization or crosslinking by heat or light, thereby becoming higher-molecular-weight molecules and losing their liquid crystallinity. Examples of preferred discotic liquid crystalline molecules are described in Japanese Patent Application Laid-Open No. 8-50206. And the details of the polymerization of discotic liquid crystalline molecules are described in Japanese Patent Application Laid-Open No. 8-27284.

To fix the discotic liquid crystalline molecules by polymerization, it is necessary to bond a polymerizable group, as a substitute, to the discotic core of the discotic liquid crystalline molecules. Compounds in which their discotic core and a polymerizable group are bonded to each other via a linking group are preferably used. With such compounds, the oriented state is maintained during the polymerization reaction. Examples of such compounds include: those described in Japanese Patent Application Laid-Open No. 2000-155216, columns [0151] to [0168].

In hybrid orientation, the angle between the long axis (disc plane) of the discotic liquid crystalline molecules and the plane of the polarizing film increases or decreases, across the depth of the optically anisotropic layer, with increase in the distance from the plane of the polarizing film. Preferably, the angle decreases with increase in the distance. The possible changes in angle include: continuous increase, continuous decrease, intermittent increase, intermittent decrease, change including both continuous increase and continuous decrease, and intermittent change including increase and decrease. The intermittent changes include the area midway across the thickness where the tilt angle does not change. Even if the change includes the area where the angle does not change, it does not matter as long as the angle increases or decreased as a whole. Preferably, the angle changes continuously.

Generally, the average direction of the long axis of the discotic liquid crystalline molecules on the polarizing film side can be adjusted by selecting the type of discotic liquid crystalline molecules or the material for the orientation film, or by selecting the method of rubbing treatment. On the other hand, generally the direction of the long axis (disc plane) of the discotic liquid crystalline molecules on the surface side (on the air side) can be adjusted by selecting the type of discotic liquid crystalline molecules or the type of the additives used together with the discotic liquid crystalline molecules. Examples of additives used with the discotic liquid crystalline molecules include: plasticizer, surfactant, polymerizable monomer, and polymer. The degree of the change in orientation in the long axis direction can also be adjusted by selecting the type of the liquid crystalline molecules and that of additives, like the above described cases.

[Other Compositions of Optically Anisotropic Layer]

Use of plasticizer, surfactant, polymerizable monomer, etc. together with the above described liquid crystalline molecules makes it possible to improve the uniformity of the coating film, the strength of the film and the orientation of liquid crystalline molecules. Preferably, such additives are compatible with the liquid crystalline molecules, and they can change the tilt angle of the liquid crystalline molecules or do not inhibit the orientation of the liquid crystalline molecules.

Examples of polymerizable monomers applicable include radically polymerizable or cationically polymerizable compounds. Preferable are radically polymerizable polyfunctional monomers which are copolymerizable with the above described polymerizable-group containing liquid crystalline compounds. Specific examples are those described in Japanese Patent Application Laid-Open No. 2002-296423, columns [0018] to [0020]. The amount of the above described compounds added is generally in the range of 1 to 50% by mass of the discotic liquid crystalline molecules and preferably in the range of 5 to 30% by mass.

Examples of surfactants include traditionally known compounds; however, fluorine compounds are particularly preferable. Specific examples of fluorine compounds include compounds described in Japanese Patent Application Laid-Open No. 2001-330725, columns [0028] to [0056].

Preferably, polymers used together with the discotic liquid crystalline molecules can change the tilt angle of the discotic liquid crystalline molecules.

Examples of polymers applicable include cellulose esters. Examples of preferred cellulose esters include those described in Japanese Patent Application Laid-Open No. 2000-155216, columns [0178]. Not to inhibit the orientation of the liquid crystalline molecules, the amount of the above described polymers added is preferably in the range of 0.1 to 10% by mass of the liquid crystalline molecules and more preferably in the range of 0.1 to 8% by mass.

The discotic nematic liquid crystal phase-solid phase transition temperature of the discotic liquid crystalline molecules is preferably 70 to 300° C. and more preferably 70 to 170° C.

[Formation of Optically Anisotropic Layer]

An optically anisotropic layer can be formed by coating the surface of the orientation film with a coating fluid that contains liquid crystalline molecules and, if necessary, polymerization initiator or any other ingredients described later.

As a solvent used for preparing the coating fluid, an organic solvent is preferably used. Examples of organic solvents applicable include: amides (e.g. N,N-dimethylformamide); sulfoxides (e.g. dimethylsulfoxide); heterocycle compounds (e.g. pyridine); hydrocarbons (e.g. benzene, hexane); alkyl halides (e.g. chloroform, dichloromethane, tetrachloroethane); esters (e.g. methyl acetate, butyl acetate); ketones (e.g. acetone, methyl ethyl ketone); and ethers (e.g. tetrahydrofuran, 1,2-dimethoxyethane). Alkyl halides and ketones are preferably used. Two or more kinds of organic solvent can be used in combination.

Such a coating fluid can be applied by a known method (e.g. wire bar coating, extrusion coating, direct gravure coating, reverse gravure coating or die coating method).

The thickness of the optically anisotropic layer is preferably 0.1 to 20 μm, more preferably 0.5 to 15 μm, and most preferably 1 to 10 μm.

[Fixation of Orientation State of Liquid Crystalline Molecules]

The oriented state of the oriented liquid crystalline molecules can be maintained and fixed. Preferably, the fixation is performed by polymerization. Types of polymerization include: heat polymerization using a heat polymerization initiator and photopolymerization using a photopolymerization initiator. For the fixation, photopolymerization is preferably used.

Examples of photopolymerization initiators include: α-carbonyl compounds (described in U.S. Pat. Nos. 2,367,661 and 2367670); acyloin ethers (described in U.S. Pat. No. 2,448,828); α-hydrocarbon-substituted aromatic acyloin compounds (U.S. Pat. No. 2,722,512); multi-nucleus quinone compounds (described in U.S. Pat. Nos. 3,046,127 and 2,951,758); combinations of triarylimidazole dimmer and p-aminophenyl ketone (described in U.S. Pat. No. 3,549,367); acridine and phenazine compounds (described in Japanese Patent Application Laid-Open No. 60-105667 and U.S. Pat. No. 4,239,850); and oxadiazole compounds (described in U.S. Pat. No. 4,212,970).

The amount of the photopolymerization initiators used is preferably in the range of 0.01 to 20% by mass of the solid content of the coating fluid and more preferably in the range of 0.5 to 5% by mass.

Light irradiation for the polymerization of liquid crystalline molecules is preferably performed using ultraviolet light.

Irradiation energy is preferably in the range of 20 mJ/cm² to 50 J/cm², more preferably 20 to 5000 mJ/cm², and much more preferably 100 to 800 mJ/cm². To accelerate the photopolymerization, light irradiation may be performed under heat.

A protective layer may be provided on the surface of the optically anisotropic layer.

Combining the optical compensation film with a polarizing layer is also preferable. Specifically, an optically anisotropic layer is formed on a polarizing film by coating the surface of the polarizing film with the above described coating fluid for an optically anisotropic layer. As a result, thin polarizer, in which stress generated with the dimensional change of polarizing film (distortion×cross-sectional area×modulus of elasticity) is small, can be prepared without using a polymer film between the polarizing film and the optically anisotropic layer. Installing the polarizing plate according to the present invention in a large-sized liquid crystal display device enables high-quality images to be displayed without causing problems such as light leakage.

Preferably, stretching is performed while keeping the tilt angle of the polarizing layer and the optical compensation layer to the angle between the transmission axis of the two sheets of polarizing plate laminated on both sides of a liquid crystal cell constituting LCD and the longitudinal or transverse direction of the liquid crystal cell. Generally the tilt angle is 45°. However, in recent years, transmissive-, reflective-, and semi-transmissive-liquid crystal display devices have been developed in which the tilt angle is not always 45°, and thus, it is preferable to adjust the stretching direction arbitrarily to the design of each LCD.

[Liquid Crystal Display Devices]

Liquid crystal modes in which the above described optical compensation film is used will be described.

(TN-Mode Liquid Crystal Display Devices)

TN-mode liquid crystal display devices are most commonly used as a color TFT liquid crystal display device and described in a large number of documents. The oriented state in a TN-mode liquid crystal cell in the black state is such that the rod-shaped liquid crystalline molecules stand in the middle of the cell while the rod-shaped liquid crystalline molecules lie near the substrates of the cell.

(OCB-Mode Liquid Crystal Display Devices)

An OCB-Mode Liquid Crystal Cell is a Bend Orientation Mode Liquid Crystal Cell where the rod-shaped liquid crystalline molecules in the upper part of the liquid cell and those in the lower part of the liquid cell are oriented in substantially opposite directions (symmetrically). Liquid crystal displays using a bend orientation mode liquid crystal cell are disclosed in U.S. Pat. Nos. 4,583,825 and 5,410,422. A bend orientation mode liquid crystal cell has a self-compensation function since the rod-shaped liquid crystalline molecules in the upper part of the liquid cell and those in the lower part are symmetrically oriented. Thus, this liquid crystal mode is also referred to as OCB (Optically Compensatory Bend) liquid crystal mode.

Like in the TN-mode cell, the oriented state in an OCB-mode liquid crystal cell in the black state is also such that the rod-shaped liquid crystalline molecules stand in the middle of the cell while the rod-shaped liquid crystalline molecules lie near the substrates of the cell.

(VA-Mode Liquid Crystal Display Devices)

VA-mode liquid crystal cells are characterized in that in the cells, rod-shaped liquid crystalline molecules are oriented substantially vertically when no voltage is applied. The VA-mode liquid crystal cells include: (1) a VA-mode liquid crystal cell in a narrow sense where rod-shaped liquid crystalline molecules are oriented substantially vertically when no voltage is applied, while they are oriented substantially horizontally when a voltage is applied (Japanese Patent Application Laid-Open No. 2-176625); (2) a MVA-mode liquid crystal cell obtained by introducing multi-domain switching of liquid crystal into a VA-mode liquid crystal cell to obtain wider viewing angle, (SID 97, Digest of Tech. Papers (Proceedings) 28 (1997) 845), (3) a n-ASM-mode liquid crystal cell where rod-shaped liquid crystalline molecules undergo substantially vertical orientation when no voltage is applied, while they undergo twisted multi-domain orientation when a voltage is applied (Proceedings 58 to 59 (1998), Symposium, Japanese Liquid Crystal Society); and (4) a SURVIVAL-mode liquid crystal cell (reported in LCD international 98).

(IPS-Mode Liquid Crystal Display Devices)

IPS-mode liquid crystal cells are characterized in that in the cells, rod-shaped liquid crystalline molecules are oriented substantially horizontally in plane when no voltage is applied and switching is performed by changing the orientation direction of the crystal in accordance with the presence or absence of application of voltage. Specific examples of IPS-mode liquid crystal cells applicable include those described in Japanese Patent Application Laid-Open Nos. 2004-365941, 2004-12731, 2004-215620, 2002-221726, 2002-55341 and 2003-195333.

(Other Modes of Liquid Crystal Display Devices)

In ECB-mode, STN (Supper Twisted Nematic)-mode, FLC (Ferroelectric Liquid Crystal)-mode, AFLC (Anti-ferroelectric Liquid Crystal)-mode, and ASM (Axially Symmetric Aligned Microcell)-mode cells, optical compensation can also be achieved with the above described logic. These cells are effective in any of the transmissive-, reflective-, and semi-transmissive-liquid crystal display devices. These are also advantageously used as an optical compensation sheet for GH (Guest-Host)-mode reflective liquid crystal display devices.

Examples of practical applications in which the cellulose derivative films described so far are used are described in Journal of Technical Disclosure (Laid-Open No. 2001-1745, Mar. 15, 2001, issued by Japan Institute of Invention and Innovation), 45-59.

[Providing Antireflection Layer (Antireflection Film)]

Generally an antireflection film is made up of: a low-refractive-index layer which also functions as a stainproof layer; and at least one layer having a refractive index higher than that of the low-refractive-index layer (i.e. high-refractive-index layer and/or intermediate-refractive-index layer) provided on a transparent substrate.

Methods of forming a multi-layer thin film as a laminate of transparent thin films of inorganic compounds (e.g. metal oxides) having different refractive indices include: chemical vapor deposition (CVD); physical vapor deposition (PVD); and a method in which a film of a colloid of metal oxide particles is formed by sol-gel process from a metal compound such as a metal alkoxide and the formed film is subjected to post-treatment (ultraviolet light irradiation: Japanese Patent Application Laid-Open No. 9-157855, plasma treatment: Japanese Patent Application Laid-Open No. 2002-327310).

On the other hand, there are proposed a various antireflection films, as highly productive antireflection films, which are formed by coating thin films of a matrix and inorganic particles dispersing therein in a laminated manner.

There is also provided an antireflection film including an antireflection layer provided with anti-glare properties, which is formed by using an antireflection film formed by coating as described above and providing the outermost surface of the film with fine irregularities.

The cellulose acylate film of the present invention is applicable to antireflection films formed by any of the above described methods, but particularly preferable is the antireflection film formed by coating (coating type antireflection film).

[Layer Configuration of Coating-Type Antireflection Film]

An antireflection film having at least on its substrate a layer construction of: intermediate-refractive-index layer, high-refractive-index layer and low-refractive-index layer (outermost layer) in this order is designed to have a refractive index satisfying the following relationship.

Refractive index of high-refractive-index layer>refractive index of intermediate-refractive-index layer>refractive index of transparent substrate>refractive index of low-refractive-index layer, and a hard coat layer may be provided between the transparent substrate and the intermediate-refractive-index layer.

The antireflection film may also be made up of: intermediate-refractive-index hard coat layer, high-refractive-index layer and low-refractive-index layer.

Examples of such antireflection films include: those described in Japanese Patent Application Laid-Open Nos. 8-122504, 8-110401, 10-300902, 2002-243906 and 2000-111706. Other functions may also be imparted to each layer. There are proposed, for example, antireflection films that include a stainproofing low-refractive-index layer or anti-static high-refractive-index layer (e.g. Japanese Patent Application Laid-Open Nos. 10-206603 and 2002-243906).

The haze of the antireflection film is preferably 5% or less and more preferably 3% or less. The strength of the film is preferably H or higher, by pencil hardness test in accordance with JIS K5400, more preferably 2H or higher, and most preferably 3H or higher.

[High-Refractive-Index Layer and Intermediate-Refractive-Index Layer]

The layer of the antireflection film having a high refractive index consists of a curable film that contains: at least ultra-fine particles of high-refractive-index inorganic compound having an average particle size of 100 nm or less; and a matrix binder.

Fine particles of high-refractive-index inorganic compound include: for example, those of inorganic compounds having a refractive index of 1.65 or more and preferably 1.9 or more. Specific examples of such inorganic compounds include: oxides of Ti, Zn, Sb, Sn, Zr, Ce, Ta, La or In; and composite oxides containing these metal atoms.

Methods of forming such ultra-fine particles include: for example, treating the particle surface with a surface treatment agent (e.g. a silane coupling agent, Japanese Patent Application Laid-Open Nos. 11-295503, 11-153703, 2000-9908, an anionic compound or organic metal coupling agent, Japanese Patent Application Laid-Open No. 2001-310432 etc.); allowing particles to have a core-shell structure in which a core is made up of high-refractive-index particle(s) (Japanese Patent Application Laid-Open No. 2001-166104 etc.); and using a specific dispersant together (Japanese Patent Application Laid-Open No. 11-153703, U.S. Pat. No. 6,210,858B1, Japanese Patent Application Laid-Open No. 2002-2776069, etc.).

Materials used for forming a matrix include: for example, conventionally known thermoplastic resins and curable resin films.

Further, as such a material, at least one composition is preferable which is selected from the group consisting of: a composition including a polyfunctional compound that has at least two radically polymerizable and/or cationically polymerizable group; an organic metal compound containing a hydrolytic group; and a composition as a partially condensed product of the above organic metal compound. Examples of such materials include: compounds described in Japanese Patent Application Laid-Open Nos. 2000-47004, 2001-315242, 2001-31871 and 2001-296401.

A curable film prepared using a colloidal metal oxide obtained from the hydrolyzed condensate of metal alkoxide and a metal alkoxide composition is also preferred. Examples are described in Japanese Patent Application Laid-Open No. 2001-293818.

The refractive index of the high-refractive-index layer is generally 1.70 to 2.20. The thickness of the high-refractive-index layer is preferably 5 nm to 10 μm and more preferably 10 nm to 1 μm.

The refractive index of the intermediate-refractive-index layer is adjusted to a value between the refractive index of the low-refractive-index layer and that of the high-refractive-index layer. The refractive index of the intermediate-refractive-index layer is preferably 1.50 to 1.70.

[Low-Refractive-Index Layer]

The low-refractive-index layer is formed on the high-refractive-index layer sequentially in the laminated manner. The refractive index of the low-refractive-index layer is 1.20 to 1.55 and preferably 1.30 to 1.50.

Preferably, the low-refractive-index layer is formed as the outermost layer having scratch resistance and stainproofing properties. As means of significantly improving scratch resistance, it is effective to provide the surface of the layer with slip properties, and conventionally known thin film forming means that includes introducing silicone or fluorine is used.

The refractive index of the fluorine-containing compound is preferably 1.35 to 1.50 and more preferably 1.36 to 1.47. The fluorine-containing compound is preferably a compound that includes a crosslinkable or polymerizable functional group containing fluorine atom in an amount of 35% to 80% by mass.

Examples of such compounds include: compounds described in Japanese Patent Application Laid-Open No. 9-222503, columns [0018] to [0026], Japanese Patent Application Laid-Open No. 11-38202, columns [0019] to [0030], Japanese Patent Application Laid-Open No. 2001-40284, columns [0027] to [0028], Japanese Patent Application Laid-Open No. 2000-284102, etc.

A silicone compound is preferably such that it has a polysiloxane structure, it includes a curable or polymerizable functional group in its polymer chain, and it has a crosslinking structure in the film. Examples of such silicone compounds include: reactive silicone (e.g. SILAPLANE manufactured by Chisso Corporation); and polysiloxane having a silanol group on each of its ends (one described in Japanese Patent Application Laid-Open No. 11-258403).

The crosslinking or polymerization reaction for preparing such fluorine-containing polymer and/or siloxane polymer containing a crosslinkable or polymerizable group is preferably carried out by radiation of light or by heating simultaneously with or after applying a coating composition for forming an outermost layer, which contains a polymerization initiator, a sensitizing agent, etc.

A sol-gel cured film is also preferable which is obtained by curing the above coating composition by the condensation reaction carried out between an organic metal compound, such as silane coupling agent, and silane coupling agent containing a specific fluorine-containing hydrocarbon group in the presence of a catalyst.

Examples of such films include: those of polyfluoroalkyl-group-containing silane compounds or the partially hydrolyzed and condensed compounds thereof (compounds described in Japanese Patent Application Laid-Open Nos. 58-142958, 58-147483, 58-147484, 9-157582 and 11-106704); and silyl compounds that contain “polyperfluoroalkyl ether” group as a fluorine-containing long-chain group (compounds described in Japanese Patent Application Laid-Open Nos. 2000-117902, 2001-48590 and 2002-53804).

The low-refractive-index layer can contain additives other than the above described ones, such as filler (e.g. low-refractive-index inorganic compounds whose primary particles have an average particle size of 1 to 150 nm, such as silicon dioxide (silica) and fluorine-containing particles (magnesium fluoride, calcium fluoride, barium fluoride); organic fine particles described in Japanese Patent Application Laid-Open No. 11-3820, columns [0020] to [0038]), silane coupling agent, slippering agent and surfactant.

When located under the outermost layer, the low-refractive-index layer may be formed by vapor phase method (vacuum evaporation, spattering, ion plating, plasma CVD, etc.). From the viewpoint of reducing producing costs, coating method is preferable.

The thickness of the low-refractive-index layer is preferably 30 to 200 nm, more preferably 50 to 150 nm, and most preferably 60 to 120 nm.

[Hard Coat Layer]

A hard coat layer is provided on the surface of both stretched and unstretched cellulose acylate films so as to impart physical strength to the antireflection film. Particularly preferably the hard coat layer is provided between the stretched cellulose acylate film and the above described high-refractive-index layer and between the unstretched cellulose acylate film and the above described high-refractive-index layer. It is also preferable to provide the hard coat layer directly on the stretched and unstretched cellulose acylate films by coating without providing an antireflection layer.

Preferably, the hard coat layer is formed by the crosslinking reaction or polymerization of compounds curable by light and/or heat. Preferred curable functional groups are photopolymerizable functional groups, and organic metal compounds having a hydrolytic functional group are preferably organic alkoxy silyl compounds.

Specific examples of such compounds include the same compounds as illustrated in the description of the high-refractive-index layer.

Specific examples of compositions that constitute the hard coat layer include: those described in Japanese Patent Application Laid-Open Nos. 2002-144913, 2000-9908 and WO 00/46617.

The high-refractive-index layer can also serve as a hard coat layer. In this case, it is preferable to form the hard coat layer using the technique described in the description of the high-refractive-index layer so that fine particles are contained in the hard coat layer in the dispersed state.

The hard coat layer can also serves as an anti-glare layer (described later), if particles having an average particle size of 0.2 to 10 μm are added to provide the layer with the anti-glare function.

The thickness of the hard coat layer can be properly designed depending on the applications for which it is used. The thickness of the hard coat layer is preferably 0.2 to 10 μm and more preferably 0.5 to 7 μm.

The strength of the hard coat layer is preferably H or higher, by pencil hardness test in accordance with JIS K5400, more preferably 2H or higher, and much more preferably 3H or higher. The hard coat layer having a smaller abrasion loss in test, before and after Taber abrasion test conducted in accordance with JIS K5400, is more preferable.

[Forward Scattering Layer]

A forward scattering layer is provided so that it provides, when applied to liquid crystal displays, the effect of improving viewing angle when the angle of vision is tilted up-, down-, right- or leftward. The above described hard coat layer can also serve as a forward scattering layer, if fine particles with different refractive index are dispersed in it.

Example of such layers include: those described in Japanese Patent Application Laid-Open No. 11-38208 where the coefficient of forward scattering is specified; those described in Japanese Patent Application Laid-Open No. 2000-199809 where the relative refractive index of transparent resin and fine particles are allowed to fall in the specified range; and those described in Japanese Patent Application Laid-Open No. 2002-107512 wherein the haze value is specified to 40% or higher.

[Other Layers]

Besides the above described layers, a primer layer, anti-static layer, undercoat layer or protective layer may be provided.

[Coating Method]

The layers of the antireflection film can be formed by any method of dip coating, air knife coating, curtain coating, roller coating, wire bar coating, gravure coating, microgravure coating and extrusion coating (U.S. Pat. No. 2,681,294).

[Anti-Glare Function]

The antireflection film may have the anti-glare function that scatters external light. The anti-glare function can be obtained by forming irregularities on the surface of the antireflection film. When the antireflection film has the anti-glare function, the haze of the antireflection film is preferably 3 to 30%, more preferably 5 to 20%, and most preferably 7 to 20%.

As a method for forming irregularities on the surface of antireflection film, any method can be employed, as long as it can maintain the surface geometry of the film. Such methods include: for example, a method in which fine particles are used in the low-refractive-index layer to form irregularities on the surface of the film (e.g. Japanese Patent Application Laid-Open No. 2000-271878); a method in which a small amount (0.1 to 50% by mass) of particles having a relatively large size (0.05 to 2 μm in particle size) are added to the layer under a low-refractive-index layer (high-refractive-index layer, intermediate-refractive-index layer or hard coat layer) to form a film having irregularities on the surface and a low-refractive-index layer is formed on the irregular surface while keeping the geometry (e.g. Japanese Patent Application Laid-Open Nos. 2000-281410, 2000-95893, 2001-100004, 2001-281407); a method in which irregularities are physically transferred on the surface of the outermost layer (stainproofing layer) having been provided (e.g. embossing described in Japanese Patent Application Laid-Open Nos. 63-278839, 11-183710, 2000-275401).

[Applications]

The unstretched and stretched cellulose acylate films of the present invention are useful as optical films, particularly as polarizing plate protective film, optical compensation sheet (also referred to as retardation film) for liquid crystal displays, optical compensation sheet for reflection-type liquid crystal displays, and substrate for silver halide photographic photosensitive materials.

Measuring methods used in the present invention will be described in the following.

(1) Modulus of Elasticity

A stress in 0.5% elongation at a tensile rate of 10%/min in an atmosphere of 70% rh at 23° C. was measured to find a modulus of elasticity. Stresses in MD and TD were measured and the average value thereof was determined to be the modulus of elasticity.

(2) Substitution Degree of Cellulose Acylate

Substitution degrees of respective acyl groups of cellulose acylate and substitution degrees of their 6th positions were found by 13C-NMR in a method described in Carbohydr. Res. 273 (1995) 83 to 91 (Tezuka, et al.).

(3) Residual Solvent

A solution obtained by dissolving 300 g of a sample film in 30 ml of methyl acetate (sample A) and a solution obtained by dissolving 300 g of a sample film in 30 ml of dichloromethane (sample B) were prepared.

These were measured in the following conditions by using gas chromatography (GC).

Column: DB-WAX (0.25 mmφ×30 m, film thickness of 0.25 μm)

Column temperature: 50° C.

Carrier gas: nitrogen.

Analysis time: 15 minutes

Sample charge amount: 1 μml

An amount of a solvent was found by the following method.

In the sample A, a content was found by using an analytical curve for each peak other than the solvent (methyl acetate), and the summation was expressed by Sa.

In the sample B, a content was found by using an analytical curve for each peak of a region hidden in the solvent peak in the sample A, and the summation was expressed by Sb.

The summation of Sa and Sb is defined to be a content of residual solvents.

(4) Loss in Weight on Heating at 220° C.

When the sample was heated at a temperature increasing rate of 10° C./min from room temperature to 400° C. under nitrogen using TG-DTA2000S manufactured by Mac Science Co., a weigh change of 10 g of the sample at 220° C. was defined to be a loss in weight on heating.

(5) Melt Viscosity

A melt viscosity was measured under the following conditions by using a viscoelasticity measuring apparatus using a cone plate (for example, modular compact rheometer: Physica MCR301, manufactured by Anton Paar Co.).

A resin was sufficiently dried to have a moisture content of 0.1% or less, and then a melt viscosity was measured at a gap of 500 μm, a temperature of 220° C. and a shear speed of 1 (/second).

(6) Re, Rth

A film was sampled at 10 points with equal intervals in the width direction of the film, and after humidity conditioning for 4 hours at 60% rh and 25° C., by using an automatic birefringence meter (KOBRA 21ADH, manufactured by Oji Scientific Instruments), retardation values in a wavelength of 590 nm from the direction perpendicular to the sample film surface and from the direction inclined at angles from +50° to −50° by an indent of 10°, from a normal line of the film surface using the slow axis as a rotational axis were measured, thereby calculating the in-plane retardation value (Re) and the retardation value in a film thickness direction (Rth).

In the following, features of the present invention will be more specifically described in reference to Examples and Comparative Examples. Suitable changes in the materials, the amount used, proportion and treatment of the same, the treatment procedure for the same, etc., which will be described in the following Examples, may be made as long as not departing from the spirit of the present invention. Accordingly, it is to be understood that the scope of the present invention is not limited to the following specific examples.

### EXAMPLES

### (1) Film Formation of Cellulose Acylate Film

First, a cellulose acylate resin (CAP-482-20, number average molecular weight of 70,000) was molten by a single-screw extruder (manufactured by TOSHIBA MACHINE CO., LTD., screw diameter: φ90 mm, L/D=30, compression ratio: 3:2) at an extraction temperature of 220° C. Then, the molten cellulose acylate resin was filtered by the leaf disc filters 56 thereafter extruding while kneading by the static mixer 27. Then, the molten cellulose acylate resin was discharged on the cooling drum 26 from the die 24 to be solidified by cooling, thereby producing a cellulose acylate film (unstretched) having a thickness of 100 μm at a line speed of 10 m/min. A discharge amount of the molten resin when discharged on the cooling drum 26 from the die 24 was set to be 300 to 400 (kg/h).

### (2) Evaluation of Cellulose Acylate Film (Unstretched)

Regarding the cellulose acylate film thus obtained, scratch defect by a die was measured. The scratch defect was evaluated by measuring a roughness of the center portion of the cellulose acylate film for a measured length of 10 mm, by a three-dimensional contact type roughness meter manufactured by Mitutoyo Corporation.

In the evaluation of scratch defect, a film having at least one of a scratch depth and width of 0.1 μm or less was expressed by “very good”, a film having a scratch depth and a width of more than 0.1 μm to 0.6 μm or less was expressed by “good”, a film having a scratch depth and a width of more than 0.6 μm to 1 μm or less was expressed by “average”, and a film having a scratch depth and a width of more than 1.0 μm was expressed by “poor”.

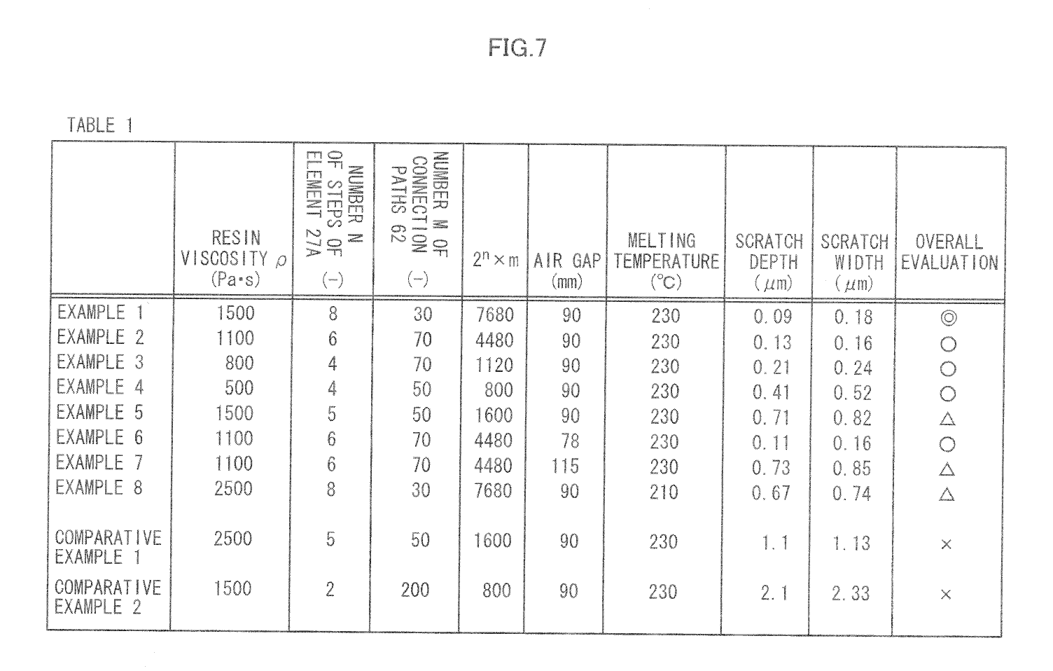

Then, die scratches of the cellulose acylate film (unstretched) was evaluated by changing the number m of the connection paths 62 in the filtration device 25 and the number n of steps of the element 27a of the static mixer 27. The result thereof is shown in Table 1 of FIG. 7.

Examples 1 to 8 in Table 1 are cases of satisfying ρ<2ⁿ×m (description of a discharge amount V of the molten resin is omitted), which is the scope of the present invention, when assumed that a viscosity of a cellulose acylate resin is ρ(Pa·s), the number of the connection paths 62 in the filtration device 25 is m (paths), and the number of steps of the elements 27a in the static mixer 27 is n (steps). Comparative Examples 1 and 2 are cases of satisfying ρ≧2ⁿ×m, which is out of the scope of the present invention.

As shown in Table 1, the cellulose acylate films in Examples 1 to 8 had both scratch depths and widths of less than 1 μm, and particularly in the conditions of Example 1, scratch defect was extremely small. Further, a 10 cm square was sampled from the film, the number of scratches was visually counted, and as a result, the number was as small as 10 scratches/10 cm in any of Examples 1 to 8.

On the other hand, in the cellulose acylate films in Comparative Examples 1 and 2, both of scratch depths and widths exceeded 2 μm and scratch defect was large. The number of scratches was more than 10 scratches/10 cm. The reason thereof is assumed that scratches formed when the molten resin passed through the hole 58 in the leaf disc filters 56 and the connection path 62 in the shaft 60 could not be removed and were remained as they are.

As described above, it was found that exhibiting scratch defect in a film after film formation can be suppressed by setting the number of the connection path 62 in the filtration device 25 and the number of steps of the element 27a in the static mixer 27 so as to satisfy ρ<2ⁿ×m of the present invention.

Further, as comparing Examples 2, 6 and 7, as an air gap is smaller, a depth and a width of scratches are smaller, and particularly in the case that the air gap is 100 mm or less, scratch defect could be effectively reduced.

Furthermore, as comparing Examples 2 and 8, a scratch depth and width were smaller than those of Example 2 in which a melting temperature was 220° C. or higher, and scratch defect was small. The reason thereof is assumed that a film with a high melting temperature has a low viscosity, and scratches are hardly formed.

### (3) Preparation of Polarizing Plate

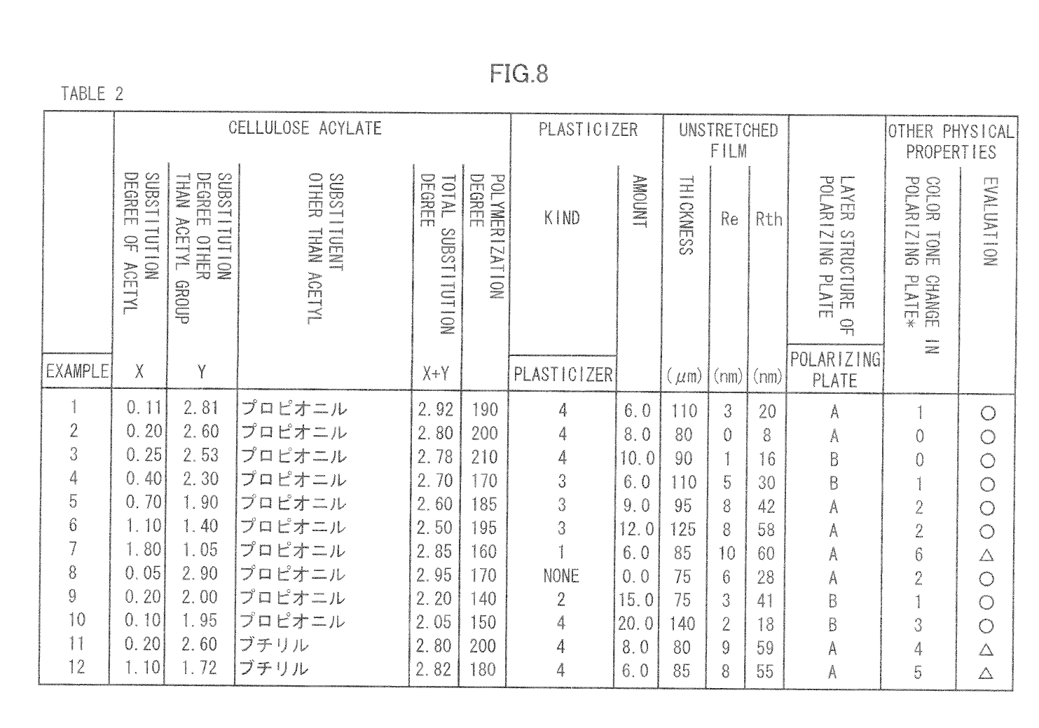

Under the film formation conditions of Example 1 (considered to be a best mode) in Table 1 of FIG. 7, unstretched films having different film materials (substitution degree, polymerization degree, and plasticizer) as described in Table 2 of FIG. 8 were produced and the following polarizing plates were prepared. In addition, the followings were used respectively as the plasticizers 1 to 4 in FIG. 8.

Plasticizer 1: biphenyl diphenyl phosphate

Plasticizer 2: dioctyl adipate

Plasticizer 3: glycerin diacetate monooleate

Plasticizer 4: polyethylene glycol (molecular weight of 600)

In addition, color tone changes in the polarizing plates were evaluated by 10 scales of small and large color variation (as the variation is greater, the color tone change is larger).

### (3-1) Saponification of Cellulose Acylate Film

Saponification was carried out on an unstretched cellulose acylate film by the following immersion saponification method. In addition, nearly the same result was obtained from a film subjected to the following coating saponification.

(i) Coating Saponification

To 80 parts by mass of isopropanol, 20 parts by mass of water was added, and KOH was dissolved therein so as to be 2.5 N, and the resultant solution adjusted to a temperature of 60° C. was used as a saponifying solution. This solution was coated on a cellulose acylate film at 60° C. by 10 g/m² and saponified for 1 minute. Then, using a warm water spray at 50° C., the film was washed by spraying at 10 L/m²·min for 1 minute.

(ii) Immersion Saponification

An aqueous solution containing 2.5 N of NaOH was used as a saponifying solution. This solution was adjusted to a temperature of 60° C. and the cellulose acylate film was immersed therein for 2 minutes. Then, the film was immersed in a 0.1 N-sulfuric acid aqueous solution for 30 minutes, thereafter passing through water washing bath.

### (3-2) Preparation of Polarizing Layer

In accordance with Example 1 in Japanese Patent Application Laid-Open No. 2001-141926, a circumferential velocity gap was given between 2 pairs of nip rolls, and stretching in a longitudinal direction, a polarizing layer with a thickness of 20 μm was prepared.

### (3-3) Lamination

The polarizing plate thus obtained, the unstretched and stretched cellulose acylate films subjected to the above described saponification treatment, and fujitac subjected to a saponification treatment (unstretched triacetate film) were laminated in the following combination in the direction of stretching the polarizing film, and in a direction (longitudinal direction) of a film formation flow of cellulose acylate by using an aqueous 3% PVA solution (PVA-117H, made by KURARAY CO., LTD.) as an adhesive.

Polarizing plate A: unstretched cellulose acylate film/polarizing layer/fujitac

Polarizing plate B: unstretched cellulose acylate film/polarizing layer/unstretched cellulose acylate film

### (3-4) Color Tone Change of Polarizing Plate

A color tone change in the polarizing plate thus obtained was evaluated by 10 scales of small and large color variation (as the variation is greater, the color tone change is larger). Any of the polarizing plates produced by carrying out the present invention resulted in favorable evaluation.

### (3-5) Evaluation of Humidity Curl

The polarizing plate thus obtained was measured by the following method. A film produced by carrying out the present invention also after processing into a polarizing plate showed preferable characteristics (low humidity curl).

Polarizing plates obtained by laminating so that a polarizing axis and a longitudinal direction of a cellulose acylate film are orthogonal and at 45 degree were produced, and the same evaluation was performed. The both plates had the same results as laminated parallelly as described above.

### (4) Preparation of Optical Compensation Film and Liquid Crystal Display Element

A polarizing plate in an observer side provided in a 22-inch crystal liquid display device (manufactured by Sharp Corporation) in which a VA type liquid crystal cell is used was separated, in the case of the above described retardation polarizing plates A and B, a polarizing plate was detached instead, and a cellulose acylate film was laminated in the observer side through an adhesive agent so that the cellulose acylate film was in the side of the liquid crystal cell. A transmittance axis of the polarizing plate in the observer side and a transmittance axis of the polarizing plate in the back light side were disposed so as to be orthogonal and a liquid crystal display device was prepared.

When the present invention was carried out also in this preparation, since humidity curl was small and films are easily laminated, deviance at the time of lamination was small.

Further, in place of the cellulose acetate film on which a liquid crystal layer in Example 1 of Japanese Patent Application Laid-Open No. 11-316378, even when the cellulose acylate film of the present invention was used, a preferable optical compensation film having less humidity curl could be prepared.

Even when an optical compensation film was produced by changing to the cellulose acylate film of the present invention in place of the cellulose acetate film on which a liquid crystal layer in Example 1 of Japanese Patent Application Laid-Open No. 7-333433 was coated, a preferable optical compensation film having less humidity curl could be prepared.

Further, when the polarizing plate and the retardation polarizing plate of the present invention were used in a liquid crystal display device described in Example 1 of Japanese Patent Application Laid-Open No. 10-48420, an optical anisotropic layer containing a discotic liquid crystal molecule and an orientation film coated with an polyvinyl alcohol described in Example 1 of Japanese Patent Application Laid-Open No. 9-26572, a 20-inch VA type liquid crystal display device described in FIGS. 2 to 9 of Japanese Patent Application Laid-Open No. 2000-154261, a 20-inch OCB type liquid crystal display device described in FIGS. 10 to 15 of Japanese Patent Application Laid-Open No. 2000-154261, and an IPS type liquid crystal display device described in FIG. 11 of Japanese Patent Application Laid-Open No. 2004-12731, preferable liquid crystal display elements having less humidity curl were obtained.

### (5) Preparation of Low-Reflective Film

The cellulose acylate film of the present invention was formed into a low-reflective film in accordance with Example 47 of technical publication of the Japan Institute of Invention and Innovation (published technique No. 2001-1745). A humidity curl of the film was measured in accordance with above mentioned method. Preferable result was obtained from a film obtained by carrying out the present invention similarly to the case of a polarizing plate.

Further, when the low-reflective film of the present invention was laminated on outermost surface layers of a liquid crystal display device described in Example 1 of Japanese Patent Application Laid-Open No. 10-48420, a 20-inch VA type liquid crystal display device described in FIGS. 2 to 9 of Japanese Patent Application Laid-Open No. 2000-154261, a 20-inch OCB type liquid crystal display device described in FIGS. 10 to 15 of Japanese Patent Application Laid-Open No. 2000-154261, and an IPS type liquid crystal display device described in FIG. 11 of Japanese Patent Application Laid-Open No. 2004-12731 and evaluations were performed, preferable liquid crystal display elements were obtained.

1-9. (canceled)

10. A method for producing a cellulose resin film, comprising the steps of:
melting a cellulose resin by an extruder, feeding the molten resin into a die through a piping, and casting the molten resin in a form of a sheet onto a running or rotating cooling support from the die to solidify the sheet by cooling, wherein
the piping comprises a filtration device having a plurality of leaf disc filters for removing a contaminant in the molten resin by the extruder circularly provided in a hollow shaft, and connection holes connecting the leaf disc filters and the shaft inside, and
a static mixer having a static element that satisfies the following condition (A) in a lower step of the filtration device, and
the molten resin from which a contaminant is removed by the leaf disc filters is rekneaded by the static mixer and fed into the die:
(A) ρ×V<2ⁿ×m×V is satisfied, when assumed that a viscosity of the molten resin is ρ(Pa·s), a discharge amount of the molten resin is V (kg/h), the number of the connection holes in the filtration device is m, and the number of steps of the static element in the static mixer is n.

11. The method for producing a cellulose resin film according to claim 10, wherein a temperature of the molten resin at a discharge opening of the die is 220° C. or higher.

12. The method for producing a cellulose resin film according to claim 10, wherein a gear pump is used as a means for conveying a liquid to the filtration device.

13. The method for producing a cellulose resin film according to claim 10, wherein a distance between a discharge opening of the die and a surface of the cooling support is 100 mm or less.

14. The method for producing a cellulose resin film according to claim 10, wherein the cooling support is in a touch roll system of nipping the molten resin discharged in a form of a sheet from the die with a pair of rollers.

15. An optical cellulose resin film, to which a method for producing a cellulose resin film according to claim 10 is applied.

16. The optical cellulose resin film according to claim 15, wherein a depth and a width of scratches formed on a surface of the optical cellulose resin film are both 1 μm or less, and the scratches are 10 scratches/10 cm or less in a lengthwise direction of the film.

17. A device for producing a cellulose resin film by melting a cellulose resin by an extruder, feeding the molten resin into a die through a piping, and casting the molten resin in a form of a sheet onto a running or rotating cooling support from the die to solidify the sheet by cooling to form a film, wherein
the piping comprises
a filtration device having a plurality of leaf disc filters for removing a contaminant in the molten resin by the extruder are circularly provided in a hollow shaft, and connection holes connecting the leaf disc filters and the shaft inside, and
a static mixer having a static element that satisfies the following condition (A) in a lower step of the filtration device:
(A) ρ×V<2ⁿ×m×V is satisfied, when assumed that a viscosity of the molten resin is ρ(Pa·s), a discharge amount of the molten resin is V (kg/h), the number of the connection holes in the filtration device is m, and the number of steps of the static element in the static mixer is n.

18. The device for producing a cellulose resin film according to claim 17, wherein a gear pump is provided between the extruder and the leaf disc filters.

19. The method for producing a cellulose resin film according to claim 11, wherein a gear pump is used as a means for conveying a liquid to the filtration device.

20. The method for producing a cellulose resin film according to claim 19, wherein a distance between a discharge opening of the die and a surface of the cooling support is 100 mm or less.

21. The method for producing a cellulose resin film according to claim 20, wherein the cooling support is in a touch roll system of nipping the molten resin discharged in a form of a sheet from the die with a pair of rollers.

22. The method for producing a cellulose resin film according to claim 11, wherein a gear pump is used as a means for conveying a liquid to the filtration device.

23. The method for producing a cellulose resin film according to claim 11, wherein a distance between a discharge opening of the die and a surface of the cooling support is 100 mm or less.

24. The method for producing a cellulose resin film according to claim 12, wherein a distance between a discharge opening of the die and a surface of the cooling support is 100 mm or less.

25. The method for producing a cellulose resin film according to claim 11, wherein the cooling support is in a touch roll system of nipping the molten resin discharged in a form of a sheet from the die with a pair of rollers.

26. The method for producing a cellulose resin film according to claim 12, wherein the cooling support is in a touch roll system of nipping the molten resin discharged in a form of a sheet from the die with a pair of rollers.

27. The method for producing a cellulose resin film according to claim 13, wherein the cooling support is in a touch roll system of nipping the molten resin discharged in a form of a sheet from the die with a pair of rollers.

28. An optical cellulose resin film, to which a method for producing a cellulose resin film according to claim 11 is applied.

29. An optical cellulose resin film, to which a method for producing a cellulose resin film according to claim 12 is applied.
